(19) United States
(12) Patent Application Publication
(10) Pub. No.: US 2026/0225364 A1
(43) Pub. Date: Aug. 6, 2026

(54) LIQUID EJECTION DEVICE

(71) Applicant: SEIKO EPSON CORPORATION, Tokyo (JP)

(72) Inventors: Kazutoshi SHIMIZU, OKAYA-SHI (JP); Hiromichi NAKASHIMA, MATSUMOTO-SHI (JP)

(21) Appl. No.: 19/460,770

(22) Filed: Jan. 27, 2026

(30) Foreign Application Priority Data
Jan. 31, 2025 (JP) 2025-014787

(51) Int. Cl. B41J 2/045; B41J 2/14; B41J 2/165; B41J 3/44; G06T 7/00

(52) U.S. Cl. CPC B41J 2/0451; B41J 2/04581; B41J 2/14201; B41J 2/1433; B41J 2/16505; B41J 2/16579; B41J 3/44; G06T 7/0002

(57) ABSTRACT

A liquid ejection device includes an ejection section; a supply section; and a control section, wherein the ejection section includes a main body portion, a nozzle plate, an actuator, and a diaphragm and the control section acquires a vibration result by detecting residual vibration of the nozzle array, determines that liquid is clinging to the nozzle array in a case where variation in the residual vibration in the vibration result is large, compares a normal result indicating the residual vibration in a state where liquid is not clinging to the nozzle array with the vibration result in a case where variation in the residual vibration in the vibration result is small, and determines that liquid is clinging to the nozzle array in a case where the residual vibration indicated by the vibration result is shorter than the residual vibration indicated by the normal result.

The present application is based on, and claims priority from JP Application Serial Number 2025-014787, filed January 31, 2025, the disclosure of which is hereby incorporated by reference herein in its entirety.

### BACKGROUND

### 1. Technical Field

The present disclosure relates to a liquid ejection device.

### 2. Related Art

JP-A-2022-49206 describes a liquid ejection device including an ejection section including a nozzle surface on which a nozzle array in which a plurality of nozzles are arranged is formed. The liquid ejection device is configured to determine that liquid is clinging to the nozzle array. A state in which liquid is clinging to the nozzle array is a state in which liquid overflows from the nozzles. When liquid overflows from the nozzles, the ejection performance of the ejection section is affected.

In such a liquid ejection device, it is determined whether or not liquid is clinging to the nozzle array by comparing states of a plurality of nozzles included in the nozzle array. Therefore, when liquid is clinging to the entire nozzle array, the plurality of nozzles are in a uniform state, and thus there is a possibility that it may not be possible to correctly determine that liquid is clinging to the nozzle array.

### SUMMARY

A liquid ejection device for overcoming the above-described problem includes an ejection section that includes a nozzle surface on which is formed a nozzle array in which a plurality of nozzles are arranged, and that ejects liquid from the plurality of nozzles; a supply section that supplies liquid to the ejection section; and a control section that inspects the nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a vibration result by detecting residual vibration of the nozzle array, determines that liquid is clinging to the nozzle array in a case where variation in the residual vibration in the vibration result is large, compares a normal result indicating the residual vibration in a state where liquid is not clinging to the nozzle array with the vibration result in a case where variation in the residual vibration in the vibration result is small, and determines that liquid is clinging to the nozzle array in a case where the residual vibration indicated by the vibration result is shorter than the residual vibration indicated by the normal result.

A liquid ejection device for overcoming the above-described problem includes an ejection section that includes a nozzle surface on which is formed a nozzle array in which a plurality of nozzles are arranged, and that ejects liquid from the plurality of nozzles; a supply section that supplies liquid to the ejection section; a cap that covers the plurality of nozzles by coming into contact with the ejection section; and a control section that inspects the nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a vibration result by detecting residual vibration of the nozzle array, determines that liquid is clinging to the nozzle array in a case where variation in the residual vibration in the vibration result is large, compares a normal result indicating the residual vibration in a state where liquid is not clinging to the nozzle array with the vibration result in a case where variation in the residual vibration in the vibration result is small, determines that liquid is not clinging to the nozzle array in a case where the residual vibration indicated by the vibration result is not shorter than the residual vibration indicated by the normal result, attaches and detaches the cap to and from the ejection section in a case where the residual vibration indicated by the vibration result is shorter than the residual vibration indicated by the normal result, acquires a re-vibration result by detecting the residual vibration of the nozzle array again after the cap is separated from the ejection section, and determines that liquid is clinging to the nozzle array in a case where variation in the residual vibration in the re-vibration result is large.

A liquid ejection device for overcoming the above-described problem includes an ejection section that includes a nozzle surface on which are formed a first nozzle array and a second nozzle array in which a plurality of nozzles are arranged, and that ejects liquid from the plurality of nozzles; a supply section that supplies liquid to the ejection section; and a control section that inspects the first nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a first vibration result by detecting residual vibration of the first nozzle array, determines that liquid is clinging to the first nozzle array in a case where variation in the residual vibration in the first vibration result is large, compares a normal result indicating the residual vibration in a state where liquid is not clinging to the first nozzle array with the first vibration result in a case where variation in the residual vibration in the first vibration result is small, determines that liquid is not clinging to the first nozzle array in a case where the residual vibration indicated by the first vibration result is not shorter than the residual vibration indicated by the normal result, compares the first vibration result with a second vibration result indicating the residual vibration of the second nozzle array in a case where the residual vibration indicated by the first vibration result is shorter than the residual vibration indicated by the normal result, and determines that liquid is clinging to the first nozzle array in a case where a difference between the residual vibration indicated by the first vibration result and the residual vibration indicated by the second vibration result is large.

A liquid ejection device for overcoming the above-described problem includes an ejection section that includes a nozzle surface on which is formed a nozzle array in which a plurality of nozzles are arranged, and that ejects liquid from the plurality of nozzles; a supply section that supplies liquid to the ejection section; a cap that covers the plurality of nozzles by coming into contact with the ejection section; a camera that photographs the nozzle surface; and a control section that inspects the nozzle array based on a photographed image photographed by the camera, wherein the control section acquires the photographed image, determines that liquid is clinging to the nozzle array in a case where there is a difference amongst the plurality of nozzles included in the nozzle array in the photographed image, attaches and detaches the cap to and from the ejection section in a case where there is no difference amongst the plurality of nozzles included in the nozzle array in the photographed image, acquires a re-photographed image photographed again by the camera after the cap is separated from the ejection section, and determines that liquid is clinging to the nozzle array in a case where there is a difference amongst the plurality of nozzles included in the nozzle array in the re-photographed image

A liquid ejection device for overcoming the above-described problem includes an ejection section that includes a nozzle surface on which are formed a first nozzle array and a second nozzle array in which a plurality of nozzles are arranged, and that ejects liquid from the plurality of nozzles; a supply section that supplies liquid to the ejection section; a camera that photographs the nozzle surface; and a control section that inspects the first nozzle array based on a photographed image photographed by the camera, wherein the control section acquires the photographed image, determines that liquid is clinging to the first nozzle array in a case where there is a difference amongst the plurality of nozzles included in the first nozzle array in the photographed image, compares the first nozzle array and the second nozzle array in the photographed image in a case where there is no difference amongst the plurality of nozzles included in the first nozzle array in the photographed image, and determines that liquid is clinging to the first nozzle array in a case where there is a difference amongst the plurality of nozzles included in the first nozzle array and the plurality of nozzles included in the second nozzle array in the photographed image.

### BRIEF DESCRIPTION OF THE DRAWINGS

FIG. 1 is a schematic diagram illustrating an embodiment of a liquid ejection device.

FIG. 2 is a bottom view of an ejection section illustrating a nozzle surface.

FIG. 3 is a graph illustrating residual vibration of a nozzle that does not overflow with liquid and is left for a long time.

FIG. 4 is a diagram illustrating the nozzle that overflows with liquid and is left for a long time.

FIG. 5 is a graph illustrating residual vibration of the nozzle that overflows with liquid and is left for a long time.

FIG. 6 is a graph illustrating a vibration result of a nozzle array in which liquid does not overflow from nozzles and that is left for a long time.

FIG. 7 is a graph illustrating a vibration result of the nozzle array to a portion of which liquid clings and that is left for a long time.

FIG. 8 is a graph illustrating a vibration result of the nozzle array to which liquid clings entirely and that is left for a long time.

FIG. 9 is a flowchart illustrating an inspection process of a first embodiment.

FIG. 10 is a flowchart illustrating an inspection process of a second embodiment.

FIG. 11 is a flowchart illustrating an inspection process of a third embodiment.

FIG. 12 is a flowchart illustrating an inspection process of a fourth embodiment.

FIG. 13 is a flowchart illustrating an inspection process of a fifth embodiment.

### DESCRIPTION OF EMBODIMENTS

Hereinafter, an embodiment of a liquid ejection device will be described with reference to the drawings. The liquid ejection device is, for example, an inkjet type printer that records an image such as a character or a photograph by ejecting ink, which is an example of liquid, onto a medium such as a paper sheet, a fabric, or a film.

### First Embodiment

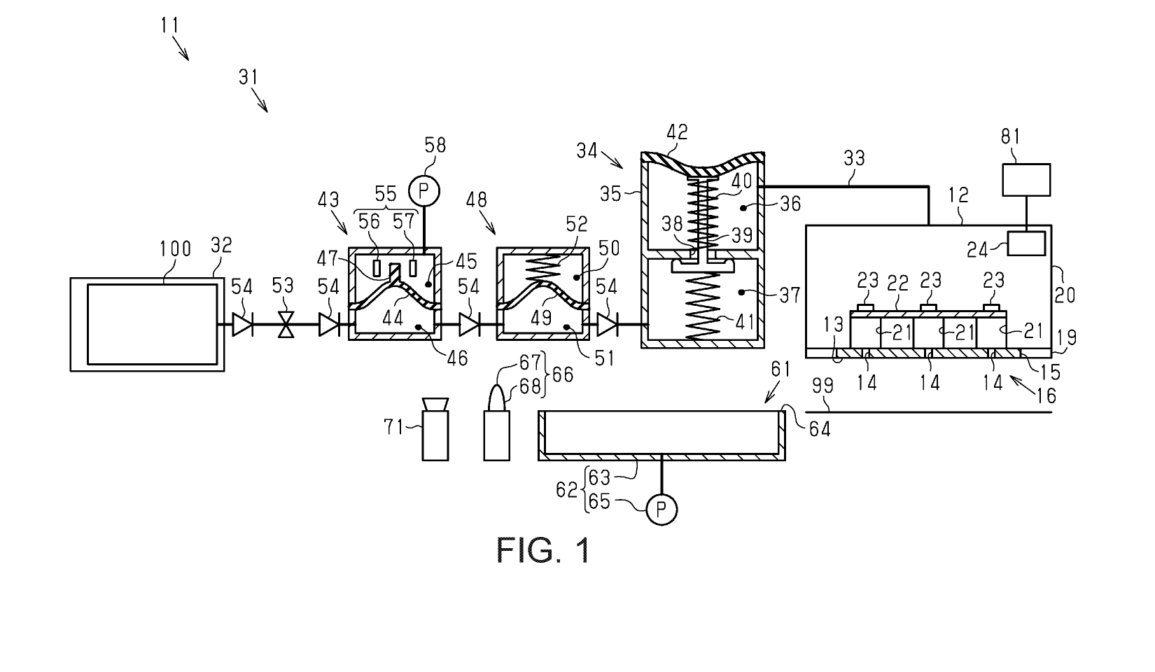

As illustrated in FIG. 1, a liquid ejection device 11 includes an ejection section 12. The ejection section 12 is configured to eject liquid. The ejection section 12 prints an image on a medium 99 by ejecting liquid onto the medium 99.

The ejection section 12 includes a nozzle surface 13. The nozzle surface 13 is a surface facing the medium 99. A plurality of nozzles 14 are opened in the nozzle surface 13. The ejection section 12 is configured to eject liquid from the plurality of nozzles 14.

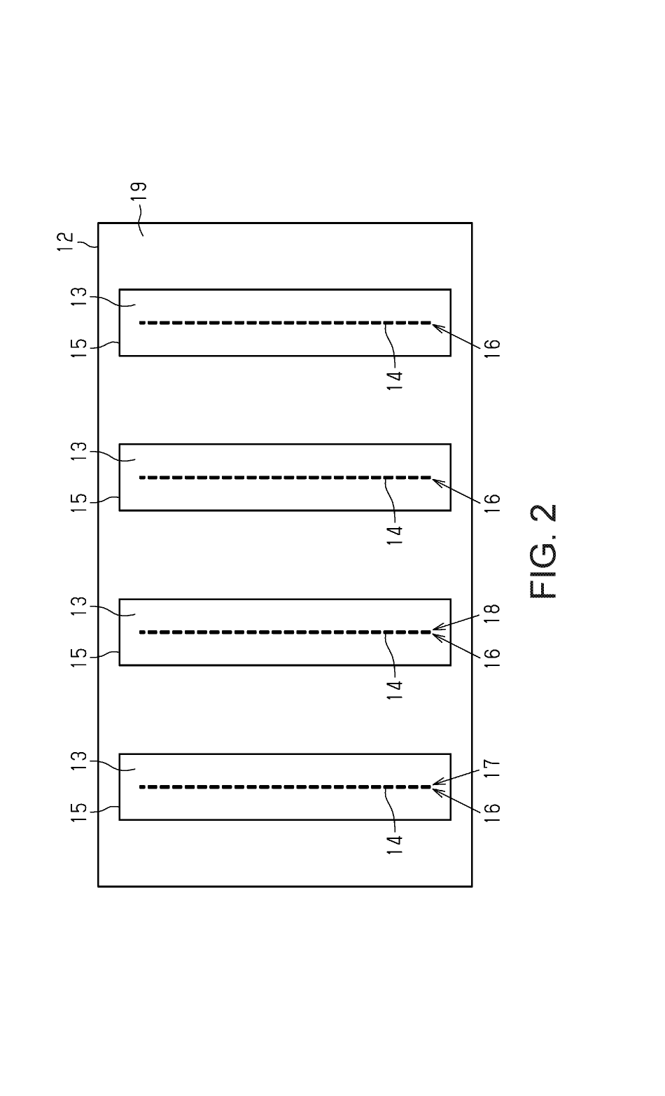

As illustrated in FIGS. 1 and 2, the ejection section 12 includes one or more nozzle plates 15. The nozzle plate 15 is a plate including the nozzle surface 13. The plurality of nozzles 14 are opened in the nozzle plate 15.

The plurality of nozzles 14 constitute one or more nozzle arrays 16. The nozzle array 16 is an array formed by arranging the plurality of nozzles 14. In one example, a plurality of nozzle arrays 16 are formed in the nozzle plate 15. One nozzle array 16 may be formed in one nozzle plate 15, or the plurality of nozzle arrays 16 may be formed in one nozzle plate 15. The plurality of nozzle arrays 16 include, for example, a first nozzle array 17 and a second nozzle array 18. The second nozzle array 18 may be the nozzle array 16 from which the same type of liquid as liquid ejected from the first nozzle array 17 is ejected, or may be the nozzle array 16 from which a different type of liquid from liquid ejected from the first nozzle array 17 is ejected. In one example, the plurality of nozzles 14 constituting the first nozzle array 17 and the plurality of nozzles 14 constituting the second nozzle array 18 eject liquid in which a contained substance is likely to settle. For example, the plurality of nozzles 14 constituting the first nozzle array 17 and the plurality of nozzles 14 constituting the second nozzle array 18 eject white ink. White ink contains a contained substance such as titanium oxide that tend to settle.

The ejection section 12 may include a fixing plate 19. The fixing plate 19 is a plate that fixes the nozzle plate 15 in the ejection section 12. The fixing plate 19 is positioned to face the medium 99 in the ejection section 12, similarly to the nozzle plate 15. The fixing plate 19 fixes the nozzle plate 15 in the ejection section 12 so as to expose the nozzle surface 13.

As illustrated in FIG. 1, the ejection section 12 includes a main body portion 20. The nozzle plate 15 is attached to the main body portion 20. The fixing plate 19 is attached to the main body portion 20. The main body portion 20 defines a plurality of liquid chambers 21. The ejection section 12 defines the liquid chambers 21 of the same number as the nozzles 14. The liquid chamber 21 is a space in the ejection section 12. The liquid chamber 21 is a space in which liquid is accommodated. The liquid chamber 21 communicates with the nozzle 14. The plurality of liquid chambers 21 communicate with the plurality of nozzles 14, respectively. The ejection section 12 is configured such that liquid is supplied to the liquid chamber 21 from the outside.

The ejection section 12 includes a diaphragm 22. The diaphragm 22 constitutes a part of a wall surface that defines the liquid chamber 21. The diaphragm 22 faces the liquid chamber 21. The diaphragm 22 is configured to apply vibration to liquid stored in the liquid chamber 21. The diaphragm 22 is configured to deform. The diaphragm 22 deforms so as to change a volume of the liquid chamber 21. The diaphragm 22 is deformed, and thus vibration is applied to liquid stored in the liquid chamber 21. By this, liquid is ejected from the nozzles 14.

The ejection section 12 includes actuators 23. The actuator 23 is attached to the diaphragm 22. Specifically, the actuator 23 is attached to a surface opposite to a surface facing the liquid chamber 21, of both surfaces of the diaphragm 22.

The actuator 23 is configured to deform the diaphragm 22. The actuator 23 is bent by applying a voltage. The actuator 23 returns to its original shape after being bent. The diaphragm 22 is deformed as the actuator 23 is bent. Specifically, when the bent actuator 23 returns to its original shape, the diaphragm 22 is bent so as to pressurize liquid in the liquid chamber 21. The actuator 23 deforms the diaphragm 22, and thus the ejection section 12 ejects liquid from the nozzle 14.

The ejection section 12 includes a drive circuit 24. The drive circuit 24 is a circuit that drives the actuators 23. The drive circuit 24 drives the actuator 23 by applying a voltage to the actuator 23. Specifically, the drive circuit 24 drives the actuator 23 by inputting a predetermined drive waveform to the actuator 23. The drive circuit 24 can generate various drive waveforms such as a drive waveform for driving the actuator 23 so as to eject liquid from the nozzle 14 and a drive waveform for driving the actuator 23 to the extent that liquid is not ejected from the nozzle 14.

The liquid ejection device 11 includes a supply section 31. The supply section 31 is configured to supply liquid to the ejection section 12. The supply section 31 is connected to the ejection section 12. The supply section 31 supplies liquid toward the liquid chambers 21.

The supply section 31 includes a mount section 32. The mount section 32 is configured such that a liquid accommodation body 100 is mounted thereon. The liquid accommodation body 100 is configured to accommodate liquid. The liquid accommodation body 100 is, for example, an ink cartridge. By mounting the liquid accommodation body 100 on the mount section 32, liquid can be supplied from the liquid accommodation body 100 to the ejection section 12.

The supply section 31 includes a supply flow path 33. The supply flow path 33 is a flow path for supplying liquid to the ejection section 12. The supply flow path 33 is connected to the ejection section 12. The supply flow path 33 is connected to the mount section 32. The supply flow path 33 connects the ejection section 12 and the mount section 32. In the supply flow path 33, liquid flows from the mount section 32 toward the ejection section 12.

The supply section 31 may include a storage section instead of the mount section 32. The storage section is a tank configured to store liquid. The supply flow path 33 may connect the ejection section 12 and the storage section. The storage section is configured to be able to be refilled with liquid from the liquid accommodation body 100, for example.

The supply section 31 includes a pressure regulating valve 34. The pressure regulating valve 34 is positioned in the supply flow path 33. In one example, the pressure regulating valve 34 is positioned between the ejection section 12 and the mount section 32 in the supply flow path 33.

The pressure regulating valve 34 is configured to open and close the supply flow path 33. When the pressure regulating valve 34 opens the supply flow path 33, liquid can be supplied from the mount section 32 to the ejection section 12. When the pressure regulating valve 34 closes the supply flow path 33, liquid supply from the mount section 32 to the ejection section 12 is blocked.

The pressure regulating valve 34 is configured to regulate a pressure in the ejection section 12. The pressure regulating valve 34 regulates a pressure in the ejection section 12 by opening and closing the supply flow path 33. Specifically, the pressure regulating valve 34 regulates a pressure of the liquid chamber 21.

The pressure regulating valve 34 is configured to maintain the inside of the ejection section 12 at a negative pressure. Specifically, the pressure regulating valve 34 maintains the inside of the ejection section 12 at a negative pressure by closing the supply flow path 33 in a case where a pressure inside the ejection section 12 is equal to or higher than a predetermined pressure. By this, a meniscus is formed in the nozzle 14. The ejection section 12 can appropriately eject liquid by forming a meniscus in the nozzle 14.

The pressure regulating valve 34 includes a main body member 35. The main body member 35 forms a pressure chamber 36, a supply chamber 37, and a through hole 38. The pressure chamber 36 is a space communicating with the inside of the ejection section 12. Therefore, a pressure of the pressure chamber 36 is substantially the same as a pressure of the liquid chamber 21. The pressure regulating valve 34 regulates a pressure of the liquid chamber 21 by regulating a pressure of the pressure chamber 36. The supply chamber 37 is a space positioned upstream of the pressure chamber 36. Specifically, the supply chamber 37 is a space positioned upstream of the pressure chamber 36 in a direction in which liquid is supplied. The through hole 38 is an opening that connects the pressure chamber 36 and the supply chamber 37. Liquid is supplied from the supply chamber 37 to the pressure chamber 36 through the through hole 38. The pressure regulating valve 34 regulates a pressure of the ejection section 12 by opening and closing the through hole 38.

The pressure regulating valve 34 includes a valve member 39. The valve member 39 is accommodated in the main body member 35. The valve member 39 is positioned to pass through the through hole 38. The valve member 39 is positioned across the pressure chamber 36 and the supply chamber 37. The valve member 39 is a valve that opens and closes the through hole 38. When the valve member 39 opens the through hole 38, liquid is supplied from the supply chamber 37 to the pressure chamber 36. That is, when the valve member 39 opens the through hole 38, the supply flow path 33 is opened. When the valve member 39 closes the through hole 38, the supply flow path 33 is closed.

The pressure regulating valve 34 includes one or more pressing members. In one example, the pressure regulating valve 34 includes a first pressing member 40 and a second pressing member 41. The pressing member is a member that presses the valve member 39. The pressing member presses the valve member 39 so that the valve member 39 closes the through hole 38. The pressing member contacts the main body member 35 and the valve member 39. The pressing member is, for example, a spring. The pressing member is accommodated in the main body member 35. The first pressing member 40 is positioned in the pressure chamber 36. The second pressing member 41 is positioned in the supply chamber 37.

The pressure regulating valve 34 includes a membrane member 42. The membrane member 42 has flexibility. The membrane member 42 is attached to the main body member 35. The membrane member 42 constitutes a part of a wall surface that defines the pressure chamber 36. The membrane member 42 faces the pressure chamber 36. The membrane member 42 deforms in accordance with a pressure of the pressure chamber 36. That is, the membrane member 42 deforms in accordance with a pressure in the ejection section 12. Specifically, the membrane member 42 deforms in accordance with a differential pressure between a pressure of the pressure chamber 36 and the atmospheric pressure. When a pressure of the pressure chamber 36 decreases, the membrane member 42 deforms so that a volume of the pressure chamber 36 decreases.

The membrane member 42 presses the valve member 39 by deforming so that a volume of the pressure chamber 36 decreases. Specifically, the membrane member 42 presses the valve member 39 so that the valve member 39 opens the through hole 38. The membrane member 42 presses the valve member 39 from the pressure chamber 36 toward the supply chamber 37. When a force of the membrane member 42 pressing the valve member 39 becomes larger than a force of the pressing member pressing the valve member 39, the valve member 39 opens the through hole 38. In this manner, the pressure regulating valve 34 regulates a pressure in the ejection section 12.

The supply section 31 includes a flow path pump 43. The flow path pump 43 is positioned in the supply flow path 33. Specifically, the flow path pump 43 is positioned upstream of the pressure regulating valve 34 in the supply flow path 33. The flow path pump 43 is positioned between the mount section 32 and the pressure regulating valve 34 in the supply flow path 33. The flow path pump 43 is, for example, a diaphragm pump. The flow path pump 43 may be a tube pump, a syringe pump, or the like. The flow path pump 43 is configured to supply liquid from the mount section 32 toward the ejection section 12.

The flow path pump 43 includes a flexible member 44. The flexible member 44 has flexibility. The flexible member 44 divides the inside of the flow path pump 43 into an air chamber 45 and a pump chamber 46. Air is stored in the air chamber 45. Liquid is stored in the pump chamber 46. The flexible member 44 deforms to pressurize the pump chamber 46. The flexible member 44 pressurizes the pump chamber 46 by deforming so that a volume of the pump chamber 46 decreases.

The flexible member 44 may include a detection portion 47. The detection portion 47 extends so as to protrude toward the air chamber 45. The detection portion 47 is used to detect that a remaining amount of liquid is small. The detection portion 47 is detected by a remaining amount sensor 55 (to be described later).

The supply section 31 may include a buffer 48. The buffer 48 is positioned in the supply flow path 33. Specifically, the buffer 48 is positioned between the flow path pump 43 and the pressure regulating valve 34 in the supply flow path 33. The buffer 48 is configured to suppress a rapid change in a pressure in the supply flow path 33 due to pressurization by the flow path pump 43.

The buffer 48 includes a deformable member 49. The deformable member 49 has flexibility. The deformable member 49 divides the inside of the buffer 48 into an accommodation chamber 50 and a buffer chamber 51. An elastic member 52 (to be described later) is accommodated in the accommodation chamber 50. The buffer chamber 51 accommodates liquid. The deformable member 49 reduces pressure fluctuation in the supply flow path 33 by deforming. The deformable member 49 deforms so that a volume of the buffer chamber 51 increases, and thus, a pressure in the supply flow path 33 is suppressed from rapidly increasing.

The buffer 48 includes an elastic member 52. The elastic member 52 is positioned in the accommodation chamber 50. The elastic member 52 presses the deformable member 49. The elastic member 52 presses the deformable member 49 so that a volume of the buffer chamber 51 decreases. By this, liquid is supplied from the buffer 48 toward the pressure regulating valve 34. The elastic member 52 is, for example, spring.

The supply section 31 includes an on-off valve 53. The on-off valve 53 is positioned in the supply flow path 33. Specifically, the on-off valve 53 is positioned upstream of the flow path pump 43 in the supply flow path 33. The on-off valve 53 is positioned between the mount section 32 and the flow path pump 43 in the supply flow path 33. The on-off valve 53 is configured to open the supply flow path 33 and close the supply flow path 33. When the on-off valve 53 closes the supply flow path 33, liquid supply from the mount section 32 to the flow path pump 43 is blocked.

The supply section 31 may include one or more one-way valves 54. In one example, the supply section 31 includes four one-way valves 54. The one-way valves 54 are positioned in the supply flow path 33. The one-way valve 54 is configured to allow liquid to flow from the mount section 32 toward the ejection section 12 and not to allow liquid to flow from the ejection section 12 toward the mount section 32. The four one-way valves 54 are positioned between the mount section 32 and the on-off valve 53, between the on-off valve 53 and the flow path pump 43, between the flow path pump 43 and the buffer 48, and between the buffer 48 and the pressure regulating valve 34, respectively, in the supply flow path 33.

The supply section 31 may include the remaining amount sensor 55. The remaining amount sensor 55 is configured to detect a remaining amount of liquid. The remaining amount sensor 55 detects a liquid remaining amount in the supply section 31. In one example, the remaining amount sensor 55 detects that a liquid remaining amount in the liquid accommodation body 100 is small.

The remaining amount sensor 55 is positioned in the flow path pump 43. Specifically, the remaining amount sensor 55 is positioned in the air chamber 45. The remaining amount sensor 55 is configured to detect the detection portion 47. The remaining amount sensor 55 detects that a remaining amount of liquid in the liquid accommodation body 100 is small based on a position of the detection portion 47. In one example, by closing the on-off valve 53, the remaining amount sensor 55 can detect a liquid remaining amount in the flow path pump 43 based on a position of the detection portion 47.

The remaining amount sensor 55 is an optical sensor. The remaining amount sensor 55 includes a light emitting element 56 and a light receiving element 57. The light emitting element 56 and the light receiving element 57 are positioned so as to face each other. The light emitting element 56 is configured to emit light toward the light receiving element 57. The light receiving element 57 is configured to receive light emitted from the light emitting element 56.

The remaining amount sensor 55 detects that a liquid remaining amount is small when the light receiving element 57 detects light emitted by the light emitting element 56. When a liquid remaining amount in the pump chamber 46 is small, the detection portion 47 retreats from between the light emitting element 56 and the light receiving element 57. At this time, the light receiving element 57 detects light of the light emitting element 56. When a liquid remaining amount in the pump chamber 46 is sufficient, the detection portion 47 is positioned between the light emitting element 56 and the light receiving element 57. At this time, the detection portion 47 of the remaining amount sensor 55 is shielded from light.

The supply section 31 includes a drive pump 58. The drive pump 58 is configured to drive the flow path pump 43. The drive pump 58 is connected to the flow path pump 43. Specifically, the drive pump 58 communicates with the air chamber 45. The drive pump 58 is configured to pressurize and depressurize the air chamber 45. The drive pump 58 pressurizes the air chamber 45 by sending air to the air chamber 45. The drive pump 58 depressurizes the air chamber 45 by drawing air from the air chamber 45. The drive pump 58 is, for example, an air pump. The drive pump 58 pressurizes the pump chamber 46 by pressurizing the air chamber 45. By this, liquid flows from the pump chamber 46 toward the ejection section 12. The drive pump 58 depressurizes the pump chamber 46 by depressurizing the air chamber 45. By this, liquid is drawn from the liquid accommodation body 100 into the pump chamber 46.

The liquid ejection device 11 includes a maintenance mechanism 61. The maintenance mechanism 61 is configured to perform maintenance on the ejection section 12. The maintenance mechanism 61 maintains the ejection section 12, and thus the ejection performance of the ejection section 12 is maintained in a favorable manner.

The maintenance mechanism 61 is configured to perform maintenance of the ejection section 12 by receiving liquid by cleaning. Cleaning is an operation of discharging liquid from the ejection section 12. By the cleaning, thickened liquid, solidified liquid, air bubbles, and the like are discharged from the ejection section 12.

The cleaning may include pressure cleaning or suction cleaning. The pressure cleaning is cleaning in which the inside of the ejection section 12 is pressurized to discharge liquid from the ejection section 12. The suction cleaning is cleaning in which liquid is discharged from the ejection section 12 by sucking the inside of the ejection section 12.

The maintenance mechanism 61 is configured to perform maintenance of the ejection section 12 by receiving liquid by flushing. Flushing is an operation of appropriately ejecting liquid from the nozzles 14. The flushing suppresses clogging of the nozzles 14.

The maintenance mechanism 61 is configured to perform maintenance of the ejection section 12 by wiping. Wiping is an operation of wiping the nozzle surface 13. By wiping, foreign matter such as liquid and dust clinging to the nozzle surface 13 is removed.

The maintenance mechanism 61 is configured to perform maintenance of the ejection section 12 by capping. Capping is an operation of forming a space communicating with the nozzles 14 by contacting the ejection section 12 so as to cover a plurality of nozzles 14. The nozzles 14 are moisturized by the capping.

The maintenance mechanism 61 includes a cap unit 62. The cap unit 62 is configured to cap the ejection section 12. The cap unit 62 may be configured to receive liquid by flushing. The cap unit 62 is configured to receive liquid by cleaning.

The cap unit 62 includes one or more caps 63. The cap 63 is configured to contact the ejection section 12. The cap 63 comes into contact with the ejection section 12 by approaching the ejection section 12. The cap 63 may come into contact with the ejection section 12 by the ejection section 12 approaching the cap 63. The cap 63 caps the ejection section 12 by coming into contact with the ejection section 12. In one example, the cap 63 caps the ejection section 12 by coming into contact with the fixing plate 19. The cap 63 may receive liquid by cleaning or may receive liquid by flushing. The cap 63 may contact the ejection section 12 so as to cover one nozzle array 16, or may contact the ejection section 12 so as to cover a plurality of nozzle arrays 16.

The cap 63 includes a contact portion 64. The contact portion 64 is a portion that comes into contact with the ejection section 12 during capping. The contact portion 64 is a portion positioned at the tip of the cap 63. The contact portion 64 is a portion of the cap 63 called a lip. In capping, the cap 63 comes into contact with the ejection section 12 such that the contact portion 64 surrounds the nozzle array 16. The cap 63 may contact the ejection section 12 such that the contact portion 64 surrounds one nozzle array 16, or may contact the ejection section 12 such that the contact portion 64 surrounds a plurality of nozzle arrays 16.

The cap 63 may be configured to be separated from the ejection section 12 in a state where the contact portion 64 is inclined with respect to the nozzle surface 13. In this case, the cap 63 is more likely to be separated from the ejection section 12 than in a case where the contact portion 64 is separated from the ejection section 12 in a state of being parallel to the nozzle surface 13.

The cap unit 62 may include a suction pump 65. The suction pump 65 is connected to the cap 63. The suction pump 65 is configured to suck the inside of the cap 63. The cap unit 62 performs suction cleaning by driving the suction pump 65 in a state in which the cap 63 caps the ejection section 12. When the suction pump 65 sucks the inside of the cap 63 in a state where the ejection section 12 is capped, a pressure inside the cap 63 decreases. By this, liquid is discharged from the nozzles 14.

The cap unit 62 may perform idle suction by driving the suction pump 65 in a state where the inside of the cap 63 is open to the atmosphere. The idle suction is an operation of discharging liquid from the inside of the cap 63.

The maintenance mechanism 61 may include a wiping unit 66. The wiping unit 66 is configured to contact the nozzle surface 13. The wiping unit 66 is configured to wipe the nozzle surface 13. The wiping unit 66 wipes the ejection section 12 by coming into contact with the nozzle surface 13.

The wiping unit 66 includes a wiper 67 and a holder 68. The wiper 67 is a member that comes into contact with the nozzle surface 13. The wiper 67 scrapes off foreign matter from the nozzle surface 13. The wiper 67 removes liquid clinging to the nozzle surface 13. The holder 68 is a member that supports the wiper 67. The holder 68 moves, for example, with respect to the ejection section 12. By this, the wiper 67 can wipe the nozzle surface 13. The ejection section 12 may be wiped by the wiping unit 66 by moving the ejection section 12 with respect to the wiping unit 66.

The liquid ejection device 11 may include a camera 71. The camera 71 is configured to photograph the nozzle surface 13. The camera 71 is configured to face the nozzle surface 13. The camera 71 may be configured to move to a position facing the nozzle surface 13. The ejection section 12 may be configured to move to a position where the nozzle surface 13 faces the camera 71.

The liquid ejection device 11 includes a control section 81. The control section 81 is configured to control the liquid ejection device 11. The control section 81 is configured to control, for example, the ejection section 12, the supply section 31, the maintenance mechanism 61, and the like.

The control section 81 may be constituted by one or more processors that execute various processes in accordance with a computer program. The control section 81 may be configured by one or more dedicated hardware circuits such as an ASIC that executes at least a part of various processes. The control section 81 may be configured by a circuit including a combination of a processor and a hardware circuit. The processor includes a CPU and memory such as a RAM and a ROM. The memory stores program codes or commands configured to cause the CPU to execute the process. Memory, that is computer-readable medium, includes any readable medium that can be accessed by a general-purpose or dedicated computer.

The control section 81 is configured to inspect the nozzles 14. In the ejection section 12, there is a possibility that a failure may occur in the nozzles 14. For example, a failure may occur in the nozzles 14 due to thickening of liquid or settling of a contained substance of liquid with the lapse of time. When a failure occurs in the nozzles 14, the ejection performance of the ejection section 12 is affected.

The control section 81 inspects the nozzles 14 based on residual vibration. Residual vibration is vibration caused by the diaphragm 22 that has been bent by the actuator 23 returning to its original shape. When the diaphragm 22 is bent by the actuator 23, vibration remains in the diaphragm 22. Residual vibration changes depending on a state in the ejection section 12. Residual vibration changes depending on a state of liquid positioned in the nozzle 14 and the liquid chamber 21. That is, the control section 81 inspects a state of liquid positioned in the nozzle 14 and the liquid chamber 21 based on residual vibration.

The control section 81 acquires residual vibration by controlling the drive circuit 24. The control section 81 controls the drive circuit 24 so as to vibrate the diaphragm 22. The control section 81 controls the drive circuit 24 so as to input a drive waveform to the actuator 23. At this time, the control section 81 may input a drive waveform accompanied by ejection of liquid from the nozzle 14 to the actuator 23, or may input a drive waveform not accompanied by ejection of liquid from the nozzle 14 to the actuator 23. When the diaphragm 22 vibrates due to a drive waveform, an electromotive force is generated in the actuator 23 in accordance with residual vibration of the diaphragm 22. That is, a voltage waveform is generated in the actuator 23 in accordance with residual vibration of the diaphragm 22. The drive circuit 24 detects residual vibration by detecting a voltage waveform of the actuator 23.

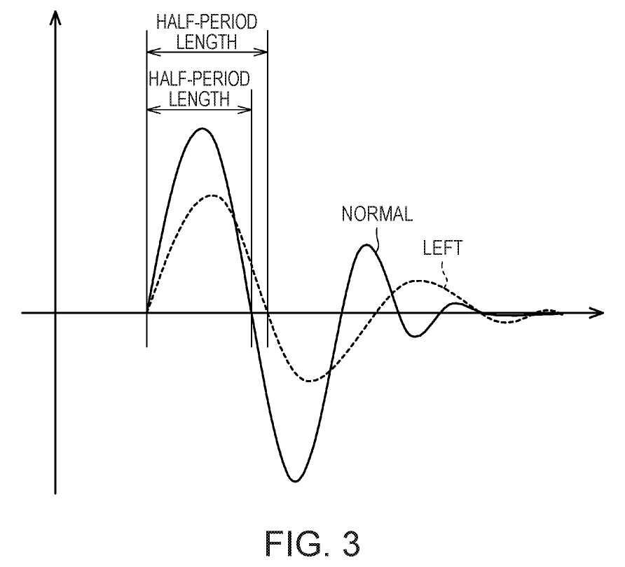

As illustrated in FIG. 3, when the ejection section 12 is left for a long time, residual vibration changes. Specifically, when a state in which liquid is not ejected from the nozzle 14 in the ejection section 12 is maintained for a long time, residual vibration changes. When the ejection section 12 is left for a long time, liquid in the ejection section 12 is dried. By this, liquid in the ejection section 12 is thickened. For example, when the ejection section 12 is left for a long time in a state of being capped, liquid in the ejection section 12 is thickened. When liquid in the ejection section 12 is thickened, the resistance due to the liquid increases, and thus residual vibration changes. When liquid in the ejection section 12 is thickened, the period of residual vibration becomes longer than that in a normal case. Specifically, a half-period length of residual vibration becomes long. When liquid in the ejection section 12 is thickened, the amplitude of residual vibration is reduced as compared with the normal case. The normal case is a case where liquid in the ejection section 12 is not thickened and the ejection section 12 can normally eject liquid from the nozzles 14.

The control section 81 confirms the thickening degree of liquid based on residual vibration. The control section 81 determines whether or not a failure occurs in the nozzles 14 based on the thickening degree of liquid. When the control section 81 determines that a failure occurs in the nozzles 14, the control section 81 may perform maintenance on the ejection section 12. The control section 81 may execute, for example, cleaning, wiping, and the like.

The control section 81 is configured to inspect the nozzle array 16. The control section 81 inspects the nozzle array 16 by inspecting the plurality of nozzles 14 constituting the nozzle array 16. The control section 81 inspects whether or not liquid is clinging to the nozzle array 16. Liquid clinging to the nozzle array 16 means that the nozzle 14 in which liquid overflows is included in the plurality of nozzles 14 constituting the nozzle array 16. That is, the control section 81 inspects whether the nozzle array 16 includes the nozzle 14 from which liquid overflows. When liquid overflows from the nozzle 14, a meniscus of the nozzle 14 is broken. Therefore, the nozzle 14 from which liquid overflows is a nozzle 14 in which a failure occurs.

The control section 81 may inspect the supply section 31 by inspecting the nozzle array 16. Specifically, the control section 81 may inspect the pressure regulating valve 34 by inspecting the nozzle array 16. When a failure occurs in the pressure regulating valve 34, the inside of the ejection section 12 is not maintained at a negative pressure, and thus there is a possibility that liquid may overflow from the nozzle 14. Therefore, when liquid overflows from the nozzle 14, it can be estimated that a failure occurs in the pressure regulating valve 34.

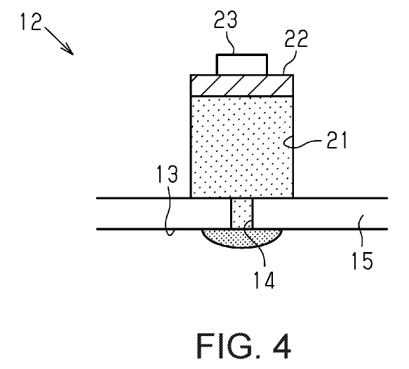

As illustrated in FIG. 4, when liquid overflows from the nozzle 14, a contained substance is likely to be collected in liquid overflowing from the nozzle 14. Specifically, when the ejection section 12 is left for a long time in a state where liquid overflows from the nozzle 14, a contained substance settles from liquid in the ejection section 12 toward liquid overflowing from the nozzle 14. By this, a contained substance is easily collected in liquid overflowing from the nozzle 14. As a result, the liquid viscosity in the ejection section 12 decreases.

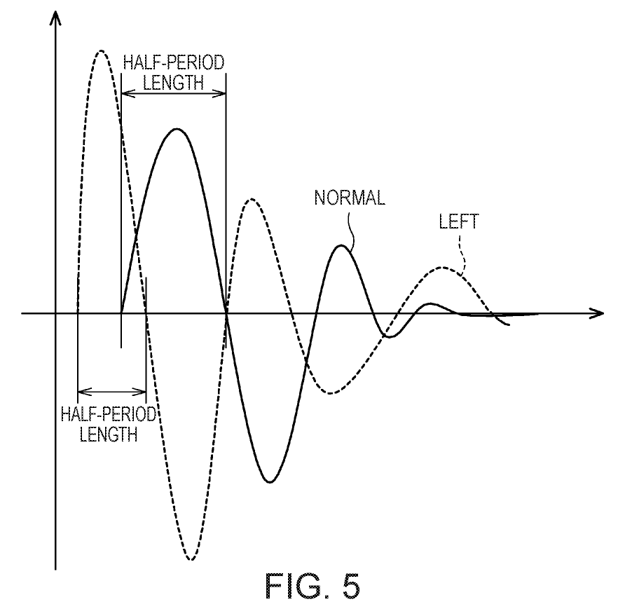

As illustrated in FIG. 5, when the ejection section 12 is left for a long time in a state where liquid overflows from the nozzle 14, residual vibration changes. When the ejection section 12 is left for a long time in a state where liquid overflows from the nozzle 14, the period of residual vibration becomes shorter than that in the normal case. Specifically, a half-period length of residual vibration is shortened. When the ejection section 12 is left for a long time in a state where liquid overflows from the nozzle 14, the amplitude of residual vibration becomes larger than that in the normal case. When the liquid viscosity in the ejection section 12 decreases, the resistance due to liquid decreases, and thus residual vibration changes.

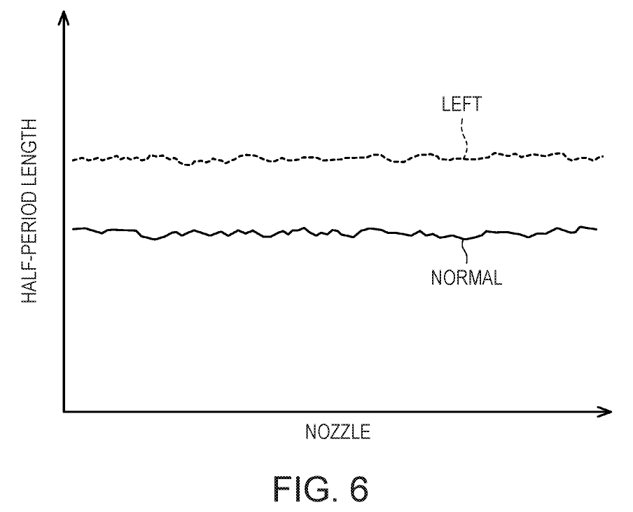

As illustrated in FIGS. 6, 7 and 8, the control section 81 acquires a vibration result by detecting residual vibration of the nozzle array 16. The vibration result is a result indicating residual vibration of each of the plurality of nozzles 14 included in the nozzle array 16. Specifically, the vibration result is a result indicating a period length of residual vibration indicated by each of the plurality of nozzles 14. In one example, the vibration result is a result indicating a half-period length of residual vibration indicated by each of the plurality of nozzles 14. In FIGS. 6, 7 and 8, a horizontal axis indicates the number of the nozzle 14, and a vertical axis indicates a half-period length of residual vibration. The control section 81 acquires the vibration result by inspecting the plurality of nozzles 14. The control section 81 inspects the nozzle array 16 based on the vibration result. The control section 81 inspects whether the nozzle 14 in which liquid overflows is included in the nozzle array 16 based on the vibration result.

The control section 81 inspects the nozzle array 16 based on variation in residual vibration. Specifically, the control section 81 inspects the nozzle array 16 based on variation in a half-period length indicated by residual vibration in the vibration result. The control section 81 determines that liquid is clinging to the nozzle array 16 when variation in residual vibration is large in the vibration result. When liquid is clinging to a portion of the nozzle array 16, liquid overflows from some nozzles 14 among the plurality of nozzles 14 constituting the nozzle array 16. In this case, the nozzle array 16 includes the nozzles 14 in which liquid overflows and the nozzles 14 in which liquid does not overflow. Residual vibration of the nozzle 14 in which liquid overflows and residual vibration of the nozzle 14 in which liquid does not overflow exhibit different vibrations. Therefore, when variation in residual vibration is large, it can be estimated that liquid is clinging to a portion of the nozzle array 16.

As illustrated in FIG. 6, when liquid is not clinging to the nozzle array 16, residual vibration indicates a uniform value. When the ejection section 12 is left for a long time, residual vibration becomes longer in the plurality of nozzles 14 as a whole than in the normal case. That is, a half-period length of residual vibration is long as a whole in the plurality of nozzles 14.

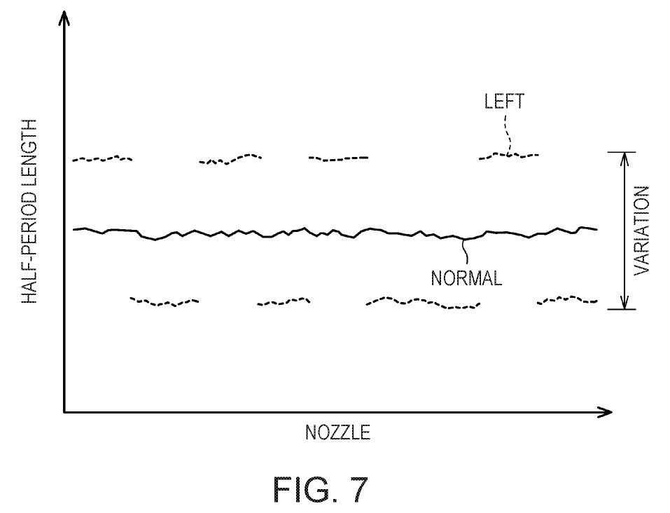

As illustrated in FIG. 7, when liquid is clinging to a portion of the nozzle array 16, residual vibration varies. In the nozzle array 16 that is left, residual vibration of the nozzle 14 in which liquid overflows is shorter than residual vibration of the nozzle 14 in which liquid does not overflow. Specifically, when the ejection section 12 is left for a long time, residual vibration is longer in the nozzle 14 in which liquid does not overflow than in the normal case. When the ejection section 12 is left for a long time, residual vibration is shorter in the nozzle 14 in which liquid overflows than in the normal case. As a result, in a vibration result, the difference between the minimum value of residual vibration and the maximum value of the residual vibration increases. In one example, the control section 81 determines whether or not variation in residual vibration is large based on the difference between the minimum value and the maximum value in a half-period length of residual vibration. The control section 81 may determine whether or not variation in residual vibration is large based on the variance in a half-period length of residual vibration.

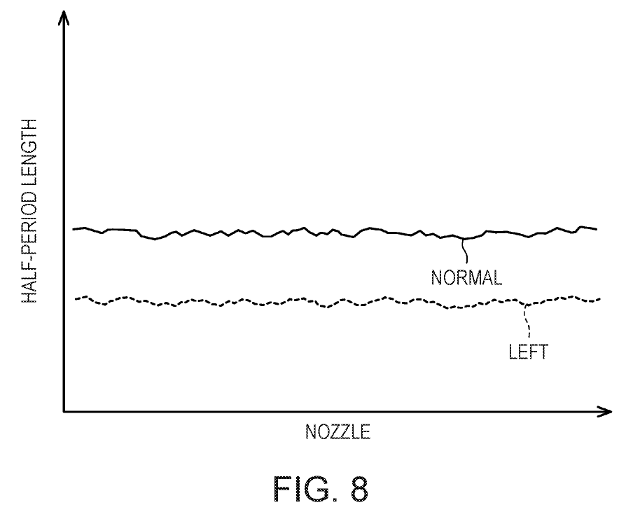

As illustrated in FIG. 8, in the ejection section 12, liquid may cling to the entire nozzle array 16. In this case, the plurality of nozzles 14 included in the nozzle array 16 are in a uniform state. That is, in a case where liquid is clinging to the entire nozzle array 16, residual vibration is unlikely to vary. Therefore, when variation in residual vibration is small, it is necessary to determine whether liquid is clinging to the entire nozzle array 16 or liquid is not clinging to the nozzle array 16.

When a failure occurs in the pressure regulating valve 34, liquid may cling to the entire nozzle array 16. Specifically, when a failure occurs in the pressure regulating valve 34, liquid gradually accumulates in the cap 63 that caps the ejection section 12. When liquid is accumulated in the cap 63, the liquid may cling to the entire nozzle array 16. In addition, when liquid is accumulated in the cap 63, the liquid is likely to cling between the nozzle plate 15 and the fixing plate 19. In this case, liquid is easily held between the nozzle plate 15 and the fixing plate 19 by a capillary force. Liquid overflowing from the nozzle 14 comes into contact with liquid held between the nozzle plate 15 and the fixing plate 19, and thus is easily held on the nozzle surface 13. By this, liquid is likely to cling to the entire nozzle array 16.

The control section 81 determines whether or not liquid is clinging to the nozzle array 16 by comparing a normal result and a vibration result. Specifically, the control section 81 compares the normal result with the vibration result when variation in residual vibration is small in the vibration result. The normal result is a vibration result in a state in which the ejection section 12 is not left for a long time and liquid can be normally ejected from the nozzles 14. The control section 81 may store the normal result in advance. The control section 81 may hold a vibration result acquired by inspecting the nozzle array 16 after maintenance of the ejection section 12 as the normal result. The control section 81 may execute maintenance and acquire a vibration result after the maintenance when the power of the liquid ejection device 11 is turned off. By this, the control section 81 may hold the normal result.

The control section 81 determines that liquid is clinging to the nozzle array 16 when residual vibration indicated by a vibration result is shorter than residual vibration indicated by the normal result. Specifically, the control section 81 determines that liquid is clinging to the nozzle array 16 when a half-period length of residual vibration indicated by a vibration result is shorter than a half-period length of residual vibration indicated by the normal result. When a half-period length indicated by a vibration result is shorter than a half-period length of residual vibration indicated by the normal result, the control section 81 determines that liquid is clinging to the entire nozzle array 16. The control section 81 may determine whether liquid is clinging to the nozzle array 16 by comparing the average value of a half-period length indicated by the normal result and the average value of a half-period length indicated by a vibration result. The control section 81 may determine whether liquid is clinging to the nozzle array 16 by comparing a half-period length for each nozzle 14 in the normal result and a vibration result.

Next, an inspection process will be described. The inspection process is a process of inspecting the nozzle array 16. The inspection process is a process of determining whether or not liquid is clinging to the nozzle array 16. The inspection process may be a process of determining whether or not the pressure regulating valve 34 has a failure. The inspection process is executed by the control section 81. The inspection process may be executed for each nozzle array 16. The inspection process of the first nozzle array 17 and the inspection process of the second nozzle array 18 may be executed in parallel or may be executed in order. The inspection process is executed by the CPU operating in accordance with a program stored in the memory. The inspection process is executed, for example, when the liquid ejection device 11 is powered on. In this case, the inspection process is executed in a state where the ejection section 12 is left from when the power is turned off to when the power is turned on. In the liquid ejection device 11, the ejection section 12 is left in a capped state while the power is off. Therefore, the inspection process may be executed in a state where the ejection section 12 is capped. The inspection process may be executed each time in response to an instruction from a user.

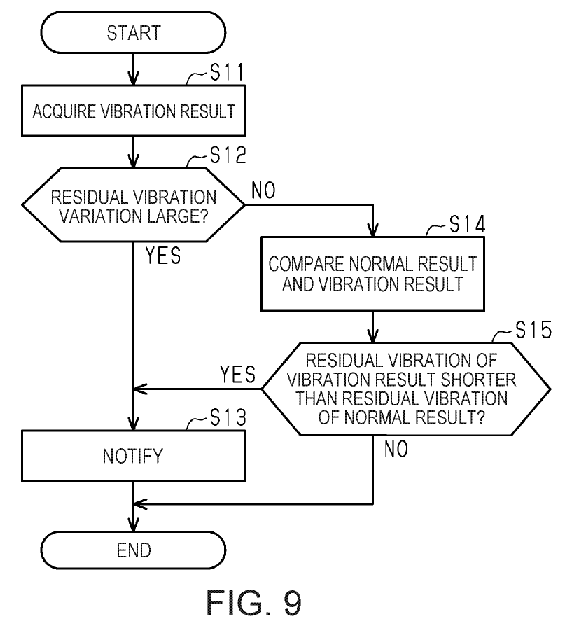

As illustrated in FIG. 9, the control section 81 acquires a vibration result of the nozzle array 16 in step S11. Specifically, the control section 81 acquires the vibration result by detecting residual vibration of the nozzle array 16. At this time, the control section 81 detects residual vibration exhibited by each of the plurality of nozzles 14 included in the nozzle array 16. The control section 81 acquires the vibration result for the nozzle array 16 by inspecting the plurality of nozzles 14.

In step S12, the control section 81 determines whether variation in residual vibration is large in the vibration result. At this time, the control section 81 determines whether the difference between the minimum value of a half-period length and the maximum value of the half-period length is large. The control section 81 determines whether the difference between the minimum value of the half-period length and the maximum value of the half-period length is large by, for example, comparing the difference with a threshold value. The control section 81 determines that liquid is clinging to the nozzle array 16 when variation in residual vibration is large. When the control section 81 determines that liquid is clinging to the nozzle array 16, the control section 81 shifts the process to step S13. When variation in residual vibration is small, the control section 81 shifts the process to step S14.

The control section 81 may notify that liquid is clinging to the nozzle array 16 in step S13. The control section 81 may display, for example, on a display included in the liquid ejection device 11, that liquid is clinging to the nozzle array 16. The control section 81 may notify that a failure occurs in the pressure regulating valve 34. The control section 81 may perform maintenance of the ejection section 12 or prompt replacement of the pressure regulating valve 34 in addition to notifying that liquid is clinging to the nozzle array 16. When the process of step S13 is completed, the control section 81 ends the inspection process.

The control section 81 compares the normal result with the vibration result in step S14. Specifically, the control section 81 compares a half-period length of residual vibration indicated by the normal result with a half-period length of residual vibration indicated by the vibration result. In one example, the control section 81 compares a half-period length of residual vibration when the power is off with a half-period length of residual vibration when the power is on. Therefore, the control section 81 confirms a change in a half-period length from the power-off to the power-on.

In step S15, the control section 81 determines whether the residual vibration indicated by the vibration result is shorter than the residual vibration indicated by the normal result. Specifically, the control section 81 determines whether the half-period length of the residual vibration indicated by the vibration result is shorter than the half-period length of the residual vibration indicated by the normal result. The control section 81 determines that liquid is clinging to the nozzle array 16 when the half-period length of the residual vibration indicated by the vibration result is shorter than the half-period length of the residual vibration indicated by the normal result. When the control section 81 determines that liquid is clinging to the nozzle array 16, the control section 81 shifts the process to step S13. When the half-period length indicated by the vibration result is not shorter than the half-period length indicated by the normal result, the control section 81 determines that liquid is not clinging to the nozzle array 16. In this case, the control section 81 ends the inspection process. After determining that liquid is not clinging to the nozzle array 16, the control section 81 may perform maintenance of the ejection section 12 in accordance with the thickening degree of liquid in the ejection section 12.

### Operations and effects of first embodiment

Next, operations and effects of the first embodiment will be described.

(1-1) The control section 81 acquires a vibration result by detecting residual vibration of the nozzle array 16. The control section 81 determines that liquid is clinging to the nozzle array 16 when variation in residual vibration is large in the vibration result. The control section 81 compares the vibration result with the normal result indicating residual vibration in a state where liquid is not clinging to the nozzle array 16 when the variation in the residual vibration is small in the vibration result. The control section 81 determines that liquid is clinging to the nozzle array 16 when residual vibration indicated by the vibration result is shorter than residual vibration indicated by the normal result. When liquid is clinging to a portion of the nozzle array 16, liquid overflows from some nozzles 14 among the plurality of nozzles 14. In the nozzle 14 in which liquid overflows, residual vibration changes as compared with the nozzle 14 in which liquid does not overflow. Therefore, when variation in residual vibration is large, it can be estimated that liquid is clinging to the nozzle array 16. On the other hand, when liquid is clinging to the entire nozzle array 16, liquid overflows from all of the plurality of nozzles 14. In this case, variation in residual vibration is reduced. Even when liquid does not overflow from all of the plurality of nozzles 14, variation in residual vibration is reduced. Therefore, when variation in residual vibration is small, it is necessary to determine whether liquid is clinging to the entire nozzle array 16 or liquid is not clinging to the nozzle array 16. When liquid overflows from the nozzle 14, the viscosity of the liquid positioned in the liquid chamber 21 is likely to decrease. Therefore, when liquid overflows from the nozzle 14, residual vibration is likely to be short. According to the above-described configuration, in a case where the residual vibration indicated by the vibration result is shorter than the residual vibration indicated by the normal result, it can be estimated that liquid is clinging to the entire nozzle array 16. Therefore, it is possible to accurately determine that liquid is clinging to the nozzle array 16.

(1-2) When the control section 81 determines that liquid is clinging to the nozzle array 16, the control section 81 notifies that a failure occurs in the pressure regulating valve 34. When a failure occurs in the pressure regulating valve 34, a pressure in the ejection section 12 is not regulated, and thus liquid may overflow from the nozzle 14. Therefore, liquid may be clinging to the nozzle array 16. Therefore, according to the above-described configuration, the control section 81 can inspect the pressure regulating valve 34 by inspecting the nozzle array 16.

### Second Embodiment

Next, a second embodiment of the liquid ejection device 11 will be described. The second embodiment is different from the first embodiment only in the content of the inspection process, and the other parts are common to the first embodiment. Therefore, in the second embodiment, the points different from the first embodiment will be mainly described. The second embodiment is different from the first embodiment in a process after comparison between the normal result and a vibration result.

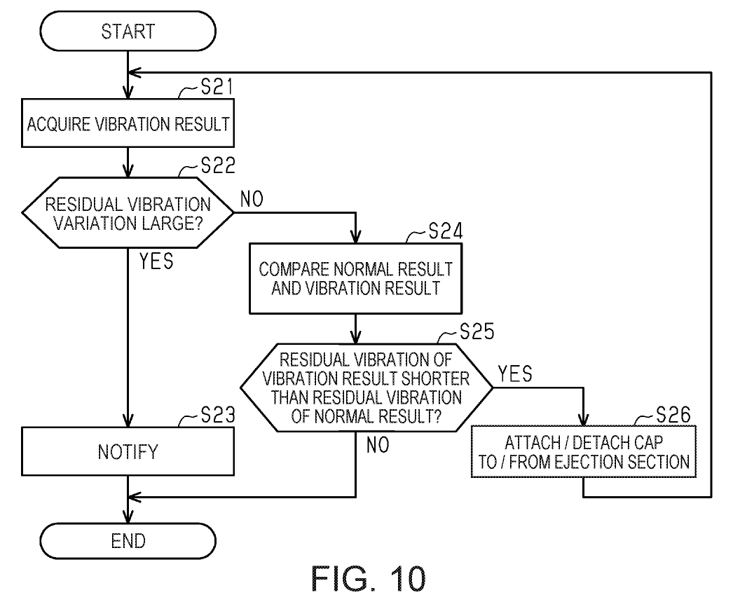

As illustrated in FIG. 10, the control section 81 operates in accordance with step S21, step S22, step S23, step S24, and step S25, as in the first embodiment. Step S21 is the same process as step S11. Step S22 is the same process as step S12. Step S23 is the same process as step S13. Step S24 is the same process as step S14. Step S25 is the same process as step S15.

In step S25, the control section 81 determines whether residual vibration indicated by a vibration result is shorter than the residual vibration indicated by the normal result. The control section 81 determines that liquid is not clinging to the nozzle array 16 when a half-period length of residual vibration indicated by the vibration result is not shorter than the half-period length of the residual vibration indicated by the normal result. In this case, the control section 81 ends the inspection process. After determining that liquid is not clinging to the nozzle array 16, the control section 81 may perform maintenance of the ejection section 12 in accordance with the thickening degree of liquid in the ejection section 12. When the half-period length of the residual vibration indicated by the vibration result is shorter than the half-period length of the residual vibration indicated by the normal result, the control section 81 shifts the process to step S26.

The control section 81 attaches and detaches the cap 63 to and from the ejection section 12 in step S26. Specifically, the control section 81 operates the cap 63 so that the cap 63 is separated from or comes into contact with the ejection section 12. The control section 81 repeats attachment and detachment of the cap 63 to and from the ejection section 12. By this, a part of liquid clinging to the nozzle array 16 is transferred to the cap 63. As a result, when liquid is clinging to the entire nozzle array 16, the state changes to a state in which liquid is clinging to a portion of the nozzle array 16.

In the liquid ejection device 11, the reliability may be higher in a case where it is determined that liquid is clinging to a portion of the nozzle array 16 than in a case where it is determined that liquid is clinging to the entire nozzle array 16. This is because a state in which liquid is clinging to the entire nozzle array 16 is rare compared to a state in which liquid is clinging to a portion of the nozzle array 16. Therefore, in the second embodiment, when there is a possibility that liquid is clinging to the entire nozzle array 16, the nozzle array 16 is changed to a state in which liquid is clinging to a portion of the nozzle array 16. By this, the control section 81 can accurately determine that liquid is clinging to the nozzle array 16.

In step S26, the control section 81 repeatedly brings the cap 63 into contact with the ejection section 12, and then separates the cap 63 from the ejection section 12. At this time, the control section 81 may separate the cap 63 from the ejection section 12 in a state where the contact portion 64 is inclined with respect to the nozzle surface 13. By this, liquid is easily transferred from the ejection section 12 to the cap 63. That is, a state in which liquid is clinging to the entire nozzle array 16 is likely to change to a state in which liquid is clinging to a portion of the nozzle array 16.

After the cap 63 is separated from the ejection section 12, the control section 81 returns the process to step S21. That is, the control section 81 performs a re-inspection on the nozzle array 16. The control section 81 acquires a re-vibration result by detecting residual vibration of the nozzle array 16 again in step S21.

In step S22, the control section 81 determines whether variation in residual vibration is large in the re-vibration result. The control section 81 determines that liquid is clinging to the nozzle array 16 when variation in residual vibration is large in the re-vibration result. The control section 81 may determine that liquid is not clinging when variation in residual vibration is small in the re-vibration result. When variation in residual vibration is small in the re-vibration result, the control section 81 may shift the process to step S24 again. In this case, the control section 81 may compare the normal result and the re-vibration result. In a case where residual vibration indicated by the re-vibration result is shorter than residual vibration indicated by the normal result, the control section 81 can shift the process to step S26 again. In a case where the residual vibration indicated by the re-vibration result is shorter than the residual vibration indicated by the normal result, the control section 81 may determine that liquid is clinging to the nozzle array 16.

### Operation and effect of second embodiment

Next, an operation and an effect of the second embodiment will be described. According to the second embodiment, the following effect is obtained in addition to the effect of (1-2).

(2-1) The control section 81 acquires a vibration result by detecting residual vibration of the nozzle array 16. The control section 81 determines that liquid is clinging to the nozzle array 16 when variation in residual vibration is large in the vibration result. The control section 81 compares the vibration result with the normal result indicating residual vibration in a state where liquid is not clinging to the nozzle array 16 when the variation in the residual vibration is small in the vibration result. When residual vibration indicated by the vibration result is not shorter than residual vibration indicated by the normal result, the control section 81 determines that liquid is not clinging to the nozzle array 16. When the residual vibration indicated by the vibration result is shorter than the residual vibration indicated by the normal result, the control section 81 attaches and detaches the cap 63 to and from the ejection section 12. The control section 81 acquires a re-vibration result by detecting residual vibration of the nozzle array 16 again after the cap 63 is separated from the ejection section 12. The control section 81 determines that liquid is clinging to the nozzle array 16 when variation in residual vibration is large in the re-vibration result. When liquid is clinging to a portion of the nozzle array 16, liquid overflows from some nozzles 14 among the plurality of nozzles 14. In the nozzle 14 in which liquid overflows, residual vibration changes as compared with the nozzle 14 in which liquid does not overflow. Therefore, when variation in residual vibration is large, it can be estimated that liquid is clinging to the nozzle array 16. On the other hand, when liquid is clinging to the entire nozzle array 16, liquid overflows from all of the plurality of nozzles 14. In this case, variation in residual vibration is reduced. Even when liquid does not overflow from all of the plurality of nozzles 14, variation in residual vibration is small. Therefore, when variation in residual vibration is small, it is necessary to determine whether liquid is clinging to the entire nozzle array 16 or liquid is not clinging to the nozzle array 16. In contrast, according to the above-described configuration, in a case where variation in residual vibration is small, that is, in a case where there is a possibility that liquid may be clinging to the entire nozzle array 16, the cap 63 is attached to and detached from the ejection section 12. By this, liquid is easily transferred from the ejection section 12 to the cap 63. That is, in a case where liquid is clinging to the entire nozzle array 16, liquid is transferred from the ejection section 12 to the cap 63, and thus, liquid is likely to be clinging to a portion of the nozzle array 16. Therefore, it is possible to accurately determine that liquid is clinging to the nozzle array 16 based on the re-vibration result.

### Third Embodiment

Next, a third embodiment of the liquid ejection device 11 will be described. The third embodiment is different from the first embodiment only in the content of the inspection process, and the other parts are common to the first embodiment. Therefore, in the third embodiment, the points different from the first embodiment will be mainly described. The third embodiment is different from the first embodiment in a process after comparison between the normal result and a vibration result. In the third embodiment, an inspection process for inspecting the first nozzle array 17 will be described.

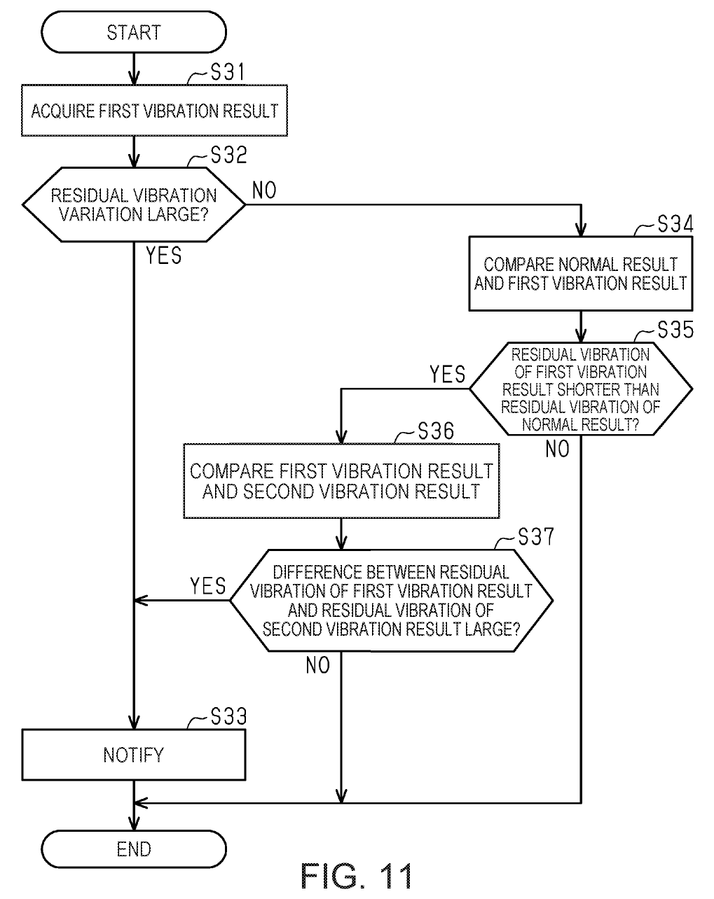

As illustrated in FIG. 11, the control section 81 acquires a first vibration result of the first nozzle array 17 in step S31. Specifically, the control section 81 acquires the first vibration result by detecting residual vibration of the first nozzle array 17. At this time, the control section 81 detects residual vibration exhibited by each of the plurality of nozzles 14 included in the first nozzle array 17. The control section 81 acquires the first vibration result for the first nozzle array 17 by inspecting the plurality of nozzles 14.

The control section 81 determines whether variation in residual vibration is large in the first vibration result in step S32. At this time, the control section 81 determines whether the difference between the minimum value of a half-period length and the maximum value of the half-period length is large. The control section 81 determines whether the difference between the minimum value of the half-period length and the maximum value of the half-period length is large by, for example, comparing the difference with a threshold value. The control section 81 determines that liquid is clinging to the first nozzle array 17 when variation in residual vibration is large. When the control section 81 determines that liquid is clinging to the first nozzle array 17, the control section 81 shifts the process to step S33. When variation in residual vibration is small, the control section 81 shifts the process to step S34.

The control section 81 may notify that liquid is clinging to the first nozzle array 17 in step S33. The control section 81 may display, for example, on a display included in the liquid ejection device 11, that liquid is clinging to the first nozzle array 17. The control section 81 may notify that a failure occurs in the pressure regulating valve 34. The control section 81 may perform maintenance of the ejection section 12 or prompt replacement of the pressure regulating valve 34 in addition to notifying that liquid is clinging to the first nozzle array 17. When the process of step S33 is completed, the control section 81 ends the inspection process.

The control section 81 compares the normal result with the first vibration result in step S34. Specifically, the control section 81 compares a half-period length of residual vibration indicated by the normal result with a half-period length of residual vibration indicated by the first vibration result. In one example, the control section 81 compares a half-period length of residual vibration when the power is off with a half-period length of residual vibration when the power is on. Therefore, the control section 81 confirms a change in a half-period length from the power-off to the power-on.

In step S35, the control section 81 determines whether the residual vibration indicated by the first vibration result is shorter than the residual vibration indicated by the normal result. Specifically, the control section 81 determines whether the half-period length of the residual vibration indicated by the first vibration result is shorter than the half-period length of the residual vibration indicated by the normal result. When the half-period length indicated by the first vibration result is not shorter than the half-period length indicated by the normal result, the control section 81 determines that liquid is not clinging to the first nozzle array 17. In this case, the control section 81 ends the inspection process. In a case where the half-period length of the residual vibration indicated by the first vibration result is shorter than the half-period length of the residual vibration indicated by the normal result, the control section 81 shifts the process to step S36.

The control section 81 compares the first vibration result and a second vibration result in step S36. The second vibration result is a vibration result indicating residual vibration of the second nozzle array 18. That is, the control section 81 compares the vibration result of the first nozzle array 17 with a vibration result of the other nozzle array 16. The control section 81 reads the second vibration result in a case where it is determined that liquid is not clinging to the second nozzle array 18. Therefore, the second vibration result is a vibration result in which residual vibration is not shorter than that in the normal result. The second vibration result is a vibration result in a state where the nozzles 14 are left without liquid overflowing. Therefore, when the difference between the residual vibration indicated by the first vibration result and residual vibration indicated by the second vibration result is large, it can be estimated that liquid is clinging to the first nozzle array 17.

The control section 81 compares the residual vibration indicated by the first vibration result and the residual vibration indicated by the second vibration result in step S36. The control section 81 compares a half-period length of the residual vibration indicated by the first vibration result and the half-period length of the residual vibration indicated by the second vibration result. The control section 81 may compare the average value of the half-period length indicated by the first vibration result and the average value of the half-period length indicated by the second vibration result. The control section 81 may compare a half-period length for each nozzle 14 in the first vibration result and the second vibration result.

In step S37, the control section 81 determines whether liquid is clinging to the first nozzle array 17 based on a comparison result of the first vibration result and the second vibration result. The control section 81 determines that liquid is clinging to the first nozzle array 17 when the difference between the residual vibration indicated by the first vibration result and the residual vibration indicated by the second vibration result is large. For example, when the difference between the half-period length of the residual vibration indicated by the first vibration result and the half-period length of the residual vibration indicated by the second vibration result is larger than a threshold value, the control section 81 determines that liquid is clinging to the entire first nozzle array 17. In a case where the difference between the residual vibration indicated by the first vibration result and the residual vibration indicated by the second vibration result is large, the control section 81 shifts the process to step S33. In a case where the difference between the residual vibration indicated by the first vibration result and the residual vibration indicated by the second vibration result is not large, the control section 81 determines that liquid is not clinging to the first nozzle array 17. In this case, the control section 81 ends the inspection process. After determining that liquid is not clinging to the first nozzle array 17, the control section 81 may perform maintenance of the ejection section 12 in accordance with the thickening degree of liquid in the ejection section 12.

### Operations and effects of third embodiment

Next, operations and effects of the third embodiment will be described. According to the third embodiment, the following effects are obtained.

(3-1) The control section 81 acquires a first vibration result by detecting residual vibration of the first nozzle array 17. The control section 81 determines that liquid is clinging to the first nozzle array 17 when variation in residual vibration is large in the first vibration result. The control section 81 compares the first vibration result with the normal result indicating residual vibration in a state where liquid is not clinging to the first nozzle array 17 when the variation in the residual vibration is small in the first vibration result. When the residual vibration indicated by the first vibration result is not shorter than the residual vibration indicated by the normal result, the control section 81 determines that liquid is not clinging to the first nozzle array 17. When the residual vibration indicated by the first vibration result is shorter than the residual vibration indicated by the normal result, the control section 81 compares the first vibration result with the second vibration result indicating residual vibration of the second nozzle array 18. The control section 81 determines that liquid is clinging to the first nozzle array 17 when the difference between the residual vibration indicated by the first vibration result and the residual vibration indicated by the second vibration result is large. When liquid is clinging to a portion of the first nozzle array 17, liquid overflows from some nozzles 14 among the plurality of nozzles 14. In the nozzle 14 in which liquid overflows, residual vibration changes as compared with the nozzle 14 in which liquid does not overflow. Therefore, when variation in residual vibration is large, it can be estimated that liquid is clinging to the first nozzle array 17. On the other hand, when liquid is clinging to the entire first nozzle array 17, liquid overflows from all of the plurality of nozzles 14. In this case, variation in residual vibration is reduced. Even when liquid does not overflow from all of the plurality of nozzles 14, variation in residual vibration is small. Therefore, when variation in residual vibration is small, it is necessary to determine whether liquid is clinging to the entire first nozzle array 17 or liquid is not clinging to the first nozzle array 17. In contrast, according to the above-described configuration, in a case where the variation in the residual vibration is small, that is, in a case where there is a possibility that liquid is clinging to the entire first nozzle array 17, the first vibration result indicating the residual vibration of the first nozzle array 17 and a second vibration result indicating residual vibration of the second nozzle array 18 are compared. When liquid is not clinging to the second nozzle array 18, the second vibration result indicates the normal result. In this case, when the difference between the residual vibration indicated by the first vibration result and the residual vibration indicated by the second vibration result is large, it can be estimated that liquid is clinging to the first nozzle array 17. Therefore, it is possible to accurately determine that liquid is clinging to the first nozzle array 17 based on the second vibration result.

(3-2) When the control section 81 determines that liquid is clinging to the first nozzle array 17, the control section 81 notifies that a failure occurs in the pressure regulating valve 34. When a failure occurs in the pressure regulating valve 34, a pressure in the ejection section 12 is not regulated, and thus liquid may overflow from the nozzle 14. Therefore, liquid may cling to the first nozzle array 17. Therefore, according to the above-described configuration, the control section 81 can inspect the pressure regulating valve 34 by inspecting the first nozzle array 17.

### Fourth Embodiment

Next, a fourth embodiment of the liquid ejection device 11 will be described. The fourth embodiment is different from the first embodiment only in the contents of the inspection process, and the other parts are common to the first embodiment. Therefore, in the fourth embodiment, the points different from the first embodiment will be mainly described. In the fourth embodiment, it is determined that liquid is clinging to the nozzle array 16 based on a photographed image photographed by the camera 71, not residual vibration.

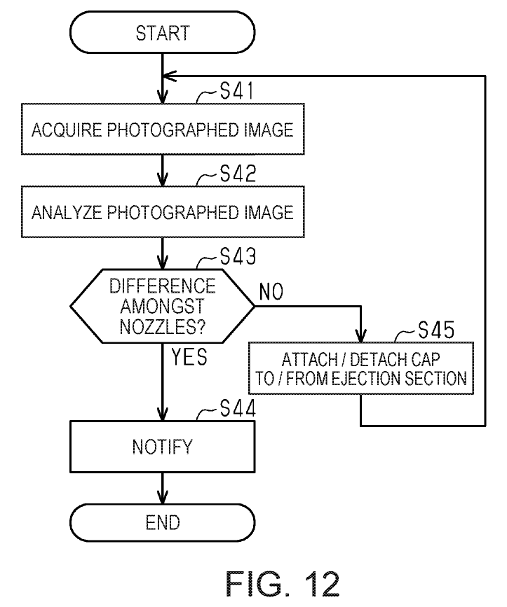

As illustrated in FIG. 12, the control section 81 acquires a photographed image in step S41. The control section 81 acquires the photographed image from the camera 71 by causing the camera 71 to photograph the nozzle surface 13.

The control section 81 analyzes the photographed image in step S42. The control section 81 inspects the nozzle array 16 by analyzing the photographed image. The control section 81 analyzes the photographed image so as to detect an edge indicating liquid, for example. The control section 81 confirms whether liquid is clinging to the nozzle array 16 by analyzing the photographed image.

In step S43, the control section 81 determines whether there is a difference amongst the plurality of nozzles 14 included in the nozzle array 16 in the photographed image. When liquid is clinging to a portion of the nozzle array 16, a nozzle 14 in which liquid overflows and a nozzle 14 in which liquid does not overflow appear different in the photographed image. Therefore, the control section 81 can determine that liquid is clinging to a portion of the nozzle array 16 by analyzing the photographed image. Therefore, when there is a difference amongst the plurality of nozzles 14 included in the nozzle array 16 in the photographed image, the control section 81 determines that liquid is clinging to the nozzle array 16. When there is a difference amongst the plurality of nozzles 14 included in the nozzle array 16 in the photographed image, the control section 81 shifts the process to step S44. When there is no difference amongst the plurality of nozzles 14 included in the nozzle array 16 in the photographed image, the control section 81 shifts the process to step S45.

The control section 81 may notify that liquid is clinging to the nozzle array 16 in step S44. The control section 81 may display, for example, on a display included in the liquid ejection device 11, that liquid is clinging to the nozzle array 16. The control section 81 may notify that a failure occurs in the pressure regulating valve 34. The control section 81 may perform maintenance of the ejection section 12 or prompt replacement of the pressure regulating valve 34 in addition to notifying that liquid is clinging to the nozzle array 16.

The control section 81 attaches and detaches the cap 63 to and from the ejection section 12 in step S45. That is, in step S45, the control section 81 executes the same process as in step S26. When there is no difference amongst the plurality of nozzles 14 included in the nozzle array 16 in the photographed image, there is a possibility that liquid is clinging to the entire nozzle array 16. When liquid is clinging to the entire nozzle array 16, liquid overflows from all of the plurality of nozzles 14. In this case, the photographed image is uniform. Therefore, in a case where liquid is clinging to the entire nozzle array 16, it is difficult to determine that liquid is clinging to the nozzle array 16 based on the photographed image. In contrast, by attaching and detaching the cap 63 to and from the ejection section 12, it is possible to change a state in which liquid is clinging to the entire nozzle array 16 to a state in which liquid is clinging to a portion of the nozzle array 16. When the control section 81 completes step S45, the control section 81 returns the process to step S41.

The control section 81 acquires a photographed image again in step S41. Specifically, the control section 81 acquires a re-photographed image by causing the camera 71 to photograph the nozzle surface 13 again.

The control section 81 analyzes the re-photographed image in step S42. The control section 81 inspects the nozzle array 16 by analyzing the re-photographed image. The control section 81 inspects the plurality of nozzles 14 included in the nozzle array 16 based on the re-photographed image.

In step S43, the control section 81 determines whether there is a difference amongst the plurality of nozzles 14 included in the nozzle array 16 in the re-photographed image. When there is a difference amongst the plurality of nozzles 14 included in the nozzle array 16 in the re-photographed image, the control section 81 determines that liquid is clinging to the nozzle array 16. When there is a difference amongst the plurality of nozzles 14 included in the nozzle array 16 in the re-photographed image, the control section 81 shifts the process to step S44. When there is no difference amongst the plurality of nozzles 14 included in the nozzle array 16 in the re-photographed image, the control section 81 may determine that liquid is not clinging to the nozzle array 16. In this case, the control section 81 may end the inspection process. After determining that liquid is not clinging to the nozzle array 16, the control section 81 may perform maintenance of the ejection section 12 in accordance with the thickening degree of liquid in the ejection section 12. When there is no difference amongst the plurality of nozzles 14 included in the nozzle array 16 in the re-photographed image, the control section 81 may shift the process to step S45 again.

### Operation and effect of fourth embodiment

Next, an operation and an effect of the fourth embodiment will be described. According to the fourth embodiment, the following effect is obtained in addition to the effect of (1-2).

(4-1) The control section 81 acquires a photographed image. The control section 81 determines that liquid is clinging to the nozzle array 16 when there is a difference amongst the plurality of nozzles 14 included in the nozzle array 16 in the photographed image. The control section 81 attaches and detaches the cap 63 to and from the ejection section 12 when there is no difference amongst the plurality of nozzles 14 included in the nozzle array 16 in the photographed image. The control section 81 acquires a re-photographed image photographed again by the camera 71 after the cap 63 is separated from the ejection section 12. The control section 81 determines that liquid is clinging to the nozzle array 16 when there is a difference amongst the plurality of nozzles 14 included in the nozzle array 16 in the re-photographed image. When liquid is clinging to a portion of the nozzle array 16, liquid overflows from some nozzles 14 among the plurality of nozzles 14. The nozzle 14 in which liquid overflows is photographed in a different manner in the photographed image compared to the nozzle 14 in which liquid does not overflow. Therefore, it can be estimated that liquid is clinging to the nozzle array 16 based on the photographed image. On the other hand, when liquid is clinging to the entire nozzle array 16, liquid overflows from all of the plurality of nozzles 14. In this case, the photographed image is uniform. Therefore, in a case where liquid is clinging to the entire nozzle array 16, it is difficult to determine that liquid is clinging to the nozzle array 16 based on the photographed image. In contrast, according to the above-described configuration, when there is no difference in the plurality of nozzles 14 in the photographed image, that is, when there is a possibility that liquid may cling to the entire nozzle array 16, the cap 63 is attached to and detached from the ejection section 12. By this, liquid is easily transferred from the ejection section 12 to the cap 63. That is, in a case where liquid is clinging to the entire nozzle array 16, liquid is transferred from the ejection section 12 to the cap 63, and thus, liquid is likely to be clinging to a portion of the nozzle array 16. Therefore, it is possible to accurately determine that liquid is clinging to the nozzle array 16 based on the re-photographed result.

### Fifth Embodiment

Next, a fifth embodiment of the liquid ejection device 11 will be described. The fifth embodiment is different from the third embodiment only in the contents of the inspection process, and the other parts are common to the third embodiment. Therefore, in the fifth embodiment, the points different from the third embodiment will be mainly described. In the fifth embodiment, as in the fourth embodiment, it is determined that liquid is clinging to the nozzle array 16 based on a photographed image photographed by the camera 71. In the fifth embodiment, it is determined that liquid is clinging to the first nozzle array 17 based on the photographed image.

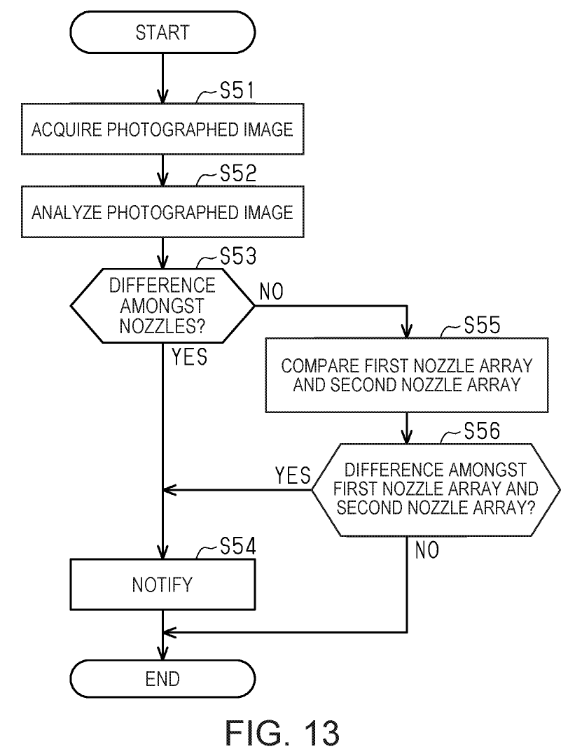

As illustrated in FIG. 13, the control section 81 operates in accordance with step S51, step S52, step S53, and step S54, as in the fourth embodiment. Step S51 is the same process as step S41. Step S52 is the same process as step S42. Step S53 is the same process as step S43. Step S54 is the same process as step S44. When there is no difference amongst the plurality of nozzles 14 included in the nozzle array 16 in the photographed image in step S53, the control section 81 shifts the process to step S55.

In step S55, the control section 81 compares the first nozzle array 17 and the second nozzle array 18 in the photographed image. In the photographed image, the other nozzle arrays 16 may be photographed in addition to the first nozzle array 17. In one example, the first nozzle array 17 and the second nozzle array 18 are photographed in the photographed image. Therefore, the control section 81 can compare the first nozzle array 17 and the second nozzle array 18 in the photographed image. The control section 81 may compare the photographed image in which the first nozzle array 17 is photographed with the photographed image in which an other nozzle array 16 is photographed. For example, the control section 81 may compare the photographed image in which the first nozzle array 17 is photographed with the photographed image in which the second nozzle array 18 is photographed. The control section 81 compares the first nozzle array 17 with the second nozzle array 18 to which liquid is determined not to be clinging. Therefore, when there is a difference amongst the first nozzle array 17 and the second nozzle array 18 in the photographed image, it can be estimated that liquid is clinging to the first nozzle array 17.

In step S55, the control section 81 compares the first nozzle array 17 and the second nozzle array 18 in the photographed image. The control section 81 compares the plurality of nozzles 14 included in the first nozzle array 17 and the plurality of nozzles 14 included in the second nozzle array 18 in the photographed image.

In step S56, the control section 81 determines whether liquid is clinging to the first nozzle array 17 based on a comparison result of the first nozzle array 17 and the second nozzle array 18. When there is a difference amongst the first nozzle array 17 and the second nozzle array 18 in the photographed image, the control section 81 determines that liquid is clinging to the first nozzle array 17. When there is a difference amongst the plurality of nozzles 14 included in the first nozzle array 17 and the plurality of nozzles 14 included in the second nozzle array 18 in the photographed image, the control section 81 determines that liquid is clinging to the entire first nozzle array 17. When there is a difference amongst the first nozzle array 17 and the second nozzle array 18, the control section 81 shifts the process to step S54. When there is no difference amongst the first nozzle array 17 and the second nozzle array 18, the control section 81 determines that liquid is not clinging to the first nozzle array 17. In this case, the control section 81 ends the inspection process. After determining that liquid is not clinging to the first nozzle array 17, the control section 81 may perform maintenance of the ejection section 12 in accordance with the thickening degree of liquid in the ejection section 12.

### Operation and effect of fifth embodiment

Next, an operation and an effect of the fifth embodiment will be described. According to the fifth embodiment, the following effect is obtained in addition to the effect of (3-2).

(5-1) The control section 81 acquires a photographed image. When there is a difference amongst the plurality of nozzles 14 included in the first nozzle array 17 in the photographed image, the control section 81 determines that liquid is clinging to the first nozzle array 17. When there is no difference amongst the plurality of nozzles 14 included in the first nozzle array 17 in the photographed image, the control section 81 compares the first nozzle array 17 and the second nozzle array 18 in the photographed image. The control section 81 determines that liquid is clinging to the first nozzle array 17 when there is a difference amongst the plurality of nozzles 14 included in the first nozzle array 17 and the plurality of nozzles 14 included in the second nozzle array 18 in the photographed image. When liquid is clinging to a portion of the first nozzle array 17, liquid overflows from some nozzles 14 among the plurality of nozzles 14. The nozzle 14 in which liquid overflows is photographed in a different manner in the photographed image compared to the nozzle 14 in which liquid does not overflow. Therefore, it can be estimated that liquid is clinging to the first nozzle array 17 based on the photographed image. On the other hand, when liquid is clinging to the entire first nozzle array 17, liquid overflows from all of the plurality of nozzles 14. In this case, the photographed image is uniform. Therefore, when liquid is clinging to the entire first nozzle array 17, it is difficult to determine whether liquid is clinging to the first nozzle array 17. In contrast, according to the above-described configuration, when there is no difference amongst the plurality of nozzles 14 included in the first nozzle array 17 in the photographed image, that is, when there is a possibility that liquid is clinging to the entire first nozzle array 17, the first nozzle array 17 and the second nozzle array 18 are compared. In a case where there is no difference amongst the plurality of nozzles 14 included in the second nozzle array 18 in the photographed image, liquid is not clinging to the second nozzle array 18. In this case, when there is a difference amongst the plurality of nozzles 14 included in the first nozzle array 17 and the plurality of nozzles 14 included in the second nozzle array 18 indicated by a comparison image in the photographed image, it can be estimated that liquid is clinging to the first nozzle array 17. Therefore, it is possible to accurately determine that liquid is clinging to the first nozzle array 17.

### Technical ideas

Hereinafter, technical ideas grasped from the above-described embodiments and operations and effects thereof will be described.

(A) A liquid ejection device includes an ejection section that includes a nozzle surface on which is formed a nozzle array in which a plurality of nozzles are arranged, and that ejects liquid from the plurality of nozzles; a supply section that supplies liquid to the ejection section; and a control section that inspects the nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a vibration result by detecting residual vibration of the nozzle array, determines that liquid is clinging to the nozzle array in a case where variation in the residual vibration in the vibration result is large, compares a normal result indicating the residual vibration in a state where liquid is not clinging to the nozzle array with the vibration result in a case where variation in the residual vibration in the vibration result is small, and determines that liquid is clinging to the nozzle array in a case where the residual vibration indicated by the vibration result is shorter than the residual vibration indicated by the normal result.

In a case where liquid is clinging to a portion of the nozzle array, liquid overflows from some of the plurality of nozzles. In the nozzle in which liquid overflows, residual vibration changes as compared with the nozzle in which liquid does not overflow. Therefore, when variation in residual vibration is large, it can be estimated that liquid is clinging to the nozzle array. On the other hand, when liquid is clinging to the entire nozzle array, liquid overflows from all of the plurality of nozzles. In this case, variation in residual vibration is reduced. Even when liquid does not overflow from all of the plurality of nozzles, variation in residual vibration is reduced. Therefore, when variation in residual vibration is small, it is necessary to determine whether liquid is clinging to the entire nozzle array or liquid is not clinging to the nozzle array. When liquid overflows from the nozzle, the viscosity of the liquid positioned in the liquid chamber is likely to decrease. Therefore, when liquid overflows from the nozzle, residual vibration is likely to be short. According to the above-described configuration, in a case where the residual vibration indicated by the vibration result is shorter than the residual vibration indicated by the normal result, it can be estimated that liquid is clinging to the entire nozzle array. Therefore, it is possible to accurately determine that liquid is clinging to the nozzle array.

(B) A liquid ejection device includes an ejection section that includes a nozzle surface on which is formed a nozzle array in which a plurality of nozzles are arranged, and that ejects liquid from the plurality of nozzles; a supply section that supplies liquid to the ejection section; a cap that covers the plurality of nozzles by coming into contact with the ejection section; and a control section that inspects the nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a vibration result by detecting residual vibration of the nozzle array, determines that liquid is clinging to the nozzle array in a case where variation in the residual vibration in the vibration result is large, compares a normal result indicating the residual vibration in a state where liquid is not clinging to the nozzle array with the vibration result in a case where variation in the residual vibration in the vibration result is small, determines that liquid is not clinging to the nozzle array in a case where the residual vibration indicated by the vibration result is not shorter than the residual vibration indicated by the normal result, attaches and detaches the cap to and from the ejection section in a case where the residual vibration indicated by the vibration result is shorter than the residual vibration indicated by the normal result, acquires a re-vibration result by detecting the residual vibration of the nozzle array again after the cap is separated from the ejection section, and determines that liquid is clinging to the nozzle array in a case where variation in the residual vibration in the re-vibration result is large.

In a case where liquid is clinging to a portion of the nozzle array, liquid overflows from some of the plurality of nozzles. In the nozzle in which liquid overflows, residual vibration changes as compared with the nozzle in which liquid does not overflow. Therefore, when variation in residual vibration is large, it can be estimated that liquid is clinging to the nozzle array. On the other hand, when liquid is clinging to the entire nozzle array, liquid overflows from all of the plurality of nozzles. In this case, variation in residual vibration is reduced. Even when liquid does not overflow from all of the plurality of nozzles, variation in residual vibration is small. Therefore, when variation in residual vibration is small, it is necessary to determine whether liquid is clinging to the entire nozzle array or liquid is not clinging to the nozzle array. In contrast, according to the above-described configuration, in a case where variation in residual vibration is small, that is, in a case where there is a possibility that liquid may cling to the entire nozzle array, the cap is attached to and detached from the ejection section. By this, liquid is easily transferred from the ejection section to the cap. That is, in a case where liquid is clinging to the entire nozzle array, liquid is transferred from the ejection section to the cap, and thus, liquid is likely to be clinging to a portion of the nozzle array. Therefore, it is possible to accurately determine that liquid is clinging to the nozzle array based on the re-vibration result.

(C) A liquid ejection device includes an ejection section that includes a nozzle surface on which are formed a first nozzle array and a second nozzle array in which a plurality of nozzles are arranged, and that ejects liquid from the plurality of nozzles; a supply section that supplies liquid to the ejection section; and a control section that inspects the first nozzle array, wherein the ejection section includes a main body portion that defines a plurality of liquid chambers, a nozzle plate that is attached to the main body portion and in which are opened the plurality of nozzles respectively communicating with the plurality of liquid chambers, an actuator, and a diaphragm that applies vibration to liquid stored in the liquid chamber by being deformed by the actuator and the control section acquires a first vibration result by detecting residual vibration of the first nozzle array, determines that liquid is clinging to the first nozzle array in a case where variation in the residual vibration in the first vibration result is large, compares a normal result indicating the residual vibration in a state where liquid is not clinging to the first nozzle array with the first vibration result in a case where variation in the residual vibration in the first vibration result is small, determines that liquid is not clinging to the first nozzle array in a case where the residual vibration indicated by the first vibration result is not shorter than the residual vibration indicated by the normal result, compares the first vibration result with a second vibration result indicating the residual vibration of the second nozzle array in a case where the residual vibration indicated by the first vibration result is shorter than the residual vibration indicated by the normal result, and determines that liquid is clinging to the first nozzle array in a case where a difference between the residual vibration indicated by the first vibration result and the residual vibration indicated by the second vibration result is large.

When liquid is clinging to a portion of the first nozzle array, liquid overflows from some of the plurality of nozzles. In the nozzle in which liquid overflows, residual vibration changes as compared with the nozzle in which liquid does not overflow. Therefore, when variation in residual vibration is large, it can be estimated that liquid is clinging to the first nozzle array. On the other hand, when liquid is clinging to the entire first nozzle array, liquid overflows from all of the plurality of nozzles. In this case, variation in residual vibration is reduced. Even when liquid does not overflow from all of the plurality of nozzles, variation in residual vibration is small. Therefore, when variation in residual vibration is small, it is necessary to determine whether liquid is clinging to the entire first nozzle array or liquid is not clinging to the nozzle array. In contrast, according to the above-described configuration, in a case where variation in residual vibration is small, that is, in a case where there is a possibility that liquid is clinging to the entire first nozzle array, the first vibration result indicating the residual vibration of the first nozzle array and the second vibration result indicating the residual vibration of the second nozzle array are compared. When liquid is not clinging to the second nozzle array, the second vibration result indicates the normal result. In this case, when the difference between the residual vibration indicated by the first vibration result and the residual vibration indicated by the second vibration result is large, it can be estimated that liquid is clinging to the first nozzle array. Therefore, it is possible to accurately determine that liquid is clinging to the first nozzle array based on the second vibration result.

(D) A liquid ejection device includes an ejection section that includes a nozzle surface on which is formed a nozzle array in which a plurality of nozzles are arranged, and that ejects liquid from the plurality of nozzles; a supply section that supplies liquid to the ejection section; a cap that covers the plurality of nozzles by coming into contact with the ejection section; a camera that photographs the nozzle surface; and a control section that inspects the nozzle array based on a photographed image photographed by the camera, wherein the control section acquires the photographed image, determines that liquid is clinging to the nozzle array in a case where there is a difference amongst the plurality of nozzles included in the nozzle array in the photographed image, attaches and detaches the cap to and from the ejection section in a case where there is no difference amongst the plurality of nozzles included in the nozzle array in the photographed image, acquires a re-photographed image photographed again by the camera after the cap is separated from the ejection section, and determines that liquid is clinging to the nozzle array in a case where there is a difference amongst the plurality of nozzles included in the nozzle array in the re-photographed image.

In a case where liquid is clinging to a portion of the nozzle array, liquid overflows from some of the plurality of nozzles. The nozzle in which liquid overflows is photographed in a different manner in the photographed image compared to the nozzle in which liquid does not overflow. Therefore, it can be estimated that liquid is clinging to the nozzle array based on the photographed image. On the other hand, in a case where liquid is clinging to the entire nozzle array, liquid overflows from all of the plurality of nozzles. In this case, the photographed image is uniform. Therefore, when liquid is clinging to the entire nozzle array, it is difficult to determine that liquid is clinging to the nozzle array based on the photographed image. In contrast, according to the above-described configuration, in a case where there is no difference amongst the plurality of nozzles in the photographed image, that is, in a case where there is a possibility that liquid may cling to the entire nozzle array, the cap is attached to and detached from the ejection section. By this, liquid is easily transferred from the ejection section to the cap. That is, in a case where liquid is clinging to the entire nozzle array, liquid is transferred from the ejection section to the cap, and thus, liquid is likely to be clinging to a portion of the nozzle array. Therefore, it is possible to accurately determine that liquid is clinging to the nozzle array based on the re-photographed result.

(E) A liquid ejection device includes an ejection section that includes a nozzle surface on which are formed a first nozzle array and a second nozzle array in which a plurality of nozzles are arranged, and that ejects liquid from the plurality of nozzles; a supply section that supplies liquid to the ejection section; a camera that photographs the nozzle surface; and a control section that inspects the first nozzle array based on a photographed image photographed by the camera, wherein the control section acquires the photographed image, determines that liquid is clinging to the first nozzle array in a case where there is a difference amongst the plurality of nozzles included in the first nozzle array in the photographed image, compares the first nozzle array and the second nozzle array in the photographed image in a case where there is no difference amongst the plurality of nozzles included in the first nozzle array in the photographed image, and determines that liquid is clinging to the first nozzle array in a case where there is a difference amongst the plurality of nozzles included in the first nozzle array and the plurality of nozzles included in the second nozzle array in the photographed image.

When liquid is clinging to a portion of the first nozzle array, liquid overflows from some of the plurality of nozzles. The nozzle in which liquid overflows is photographed in a different manner in the photographed image compared to the nozzle in which liquid does not overflow. Therefore, it can be estimated that liquid is clinging to the first nozzle array based on the photographed image. On the other hand, in a case where liquid is clinging to the entire first nozzle array, liquid overflows from all of the plurality of nozzles. In this case, the photographed image is uniform. Therefore, when liquid is clinging to the entire first nozzle array, it is difficult to determine whether liquid is not clinging to the first nozzle array. In contrast, according to the above-described configuration, in a case where there is no difference amongst the plurality of nozzles included in the first nozzle array in the photographed image, that is, in a case where there is a possibility that liquid may cling to the entire first nozzle array, the first nozzle array and the second nozzle array are compared. In a case where there is no difference amongst the plurality of nozzles included in the second nozzle array in the photographed image, liquid is not clinging to the second nozzle array. In this case, when there is a difference amongst the plurality of nozzles included in the first nozzle array and the plurality of nozzles included in the second nozzle array indicated by a comparison image in the photographed image, it can be estimated that liquid is clinging to the first nozzle array. Therefore, it is possible to accurately determine that liquid is clinging to the first nozzle array.

(F) The above-described liquid ejection device may be configured such that the supply section includes a pressure regulating valve that regulates a pressure in the ejection section and the control section notifies that a failure occurs in the pressure regulating valve in a case where the control section determines that liquid is clinging to the nozzle array.

When a failure occurs in the pressure regulating valve, liquid may overflow from the nozzle due to a pressure in the ejection section not being regulated. Therefore, liquid may cling to the nozzle array. Therefore, according to the above-described configuration, the control section can inspect the pressure regulating valve by inspecting the nozzle array.

(G) The above-described liquid ejection device may be configured such that the supply section includes a pressure regulating valve that regulates a pressure in the ejection section and the control section notifies that a failure occurs in the pressure regulating valve in a case where the control section determines that liquid is clinging to the first nozzle array.

When a failure occurs in the pressure regulating valve, liquid may overflow from the nozzle due to a pressure in the ejection section not being regulated. Therefore, liquid may cling to the first nozzle array. Therefore, according to the above-described configuration, the control section can inspect the pressure regulating valve by inspecting the first nozzle array.

What is claimed is:

1. A liquid ejection device comprising:
an ejection section that includes a nozzle surface on which is formed a nozzle array in which a plurality of nozzles are arranged, and that ejects liquid from the plurality of nozzles;
a supply section that supplies liquid to the ejection section; and
a control section that inspects the nozzle array, wherein
the ejection section includes
a main body portion that defines a plurality of liquid chambers,
a nozzle plate that is attached to the main body portion and in which are opened the plurality of nozzles respectively communicating with the plurality of liquid chambers,
an actuator, and
a diaphragm that applies vibration to liquid stored in the liquid chamber by being deformed by the actuator and
the control section
acquires a vibration result by detecting residual vibration of the nozzle array,
determines that liquid is clinging to the nozzle array in a case where variation in the residual vibration in the vibration result is large,
compares a normal result indicating the residual vibration in a state where liquid is not clinging to the nozzle array with the vibration result in a case where variation in the residual vibration in the vibration result is small, and
determines that liquid is clinging to the nozzle array in a case where the residual vibration indicated by the vibration result is shorter than the residual vibration indicated by the normal result.

2. A liquid ejection device comprising:
an ejection section that includes a nozzle surface on which is formed a nozzle array in which a plurality of nozzles are arranged, and that ejects liquid from the plurality of nozzles;
a supply section that supplies liquid to the ejection section;
a cap that covers the plurality of nozzles by coming into contact with the ejection section;
a camera that photographs the nozzle surface; and
a control section that inspects the nozzle array based on a photographed image photographed by the camera, wherein
the control section
acquires the photographed image,
determines that liquid is clinging to the nozzle array in a case where there is a difference amongst the plurality of nozzles included in the nozzle array in the photographed image,
attaches and detaches the cap to and from the ejection section in a case where there is no difference amongst the plurality of nozzles included in the nozzle array in the photographed image,
acquires a re-photographed image photographed again by the camera after the cap is separated from the ejection section, and
determines that liquid is clinging to the nozzle array in a case where there is a difference amongst the plurality of nozzles included in the nozzle array in the re-photographed image.

3. A liquid ejection device comprising:
an ejection section that includes a nozzle surface on which are formed a first nozzle array and a second nozzle array in which a plurality of nozzles are arranged, and that ejects liquid from the plurality of nozzles;
a supply section that supplies liquid to the ejection section;
a camera that photographs the nozzle surface; and
a control section that inspects the first nozzle array based on a photographed image photographed by the camera, wherein
the control section
acquires the photographed image,
determines that liquid is clinging to the first nozzle array in a case where there is a difference amongst the plurality of nozzles included in the first nozzle array in the photographed image,
compares the first nozzle array and the second nozzle array in the photographed image in a case where there is no difference amongst the plurality of nozzles included in the first nozzle array in the photographed image, and
determines that liquid is clinging to the first nozzle array in a case where there is a difference amongst the plurality of nozzles included in the first nozzle array and the plurality of nozzles included in the second nozzle array in the photographed image.

4. The liquid ejection device according to claim 1, wherein
the supply section includes a pressure regulating valve that regulates a pressure in the ejection section and
the control section notifies that a failure occurs in the pressure regulating valve in a case where the control section determines that liquid is clinging to the nozzle array.

5. The liquid ejection device according to claim 3, wherein
the supply section includes a pressure regulating valve that regulates a pressure in the ejection section and
the control section notifies that a failure occurs in the pressure regulating valve in a case where the control section determines that liquid is clinging to the first nozzle array.
